(19) United States
(12) Patent Application Publication
(10) Pub. No.: US 2026/0161107 A1
(43) Pub. Date: Jun. 11, 2026

(54) METHOD OF MANUFACTURING RESIN FINE PARTICLES, RESIN FINE PARTICLE COMPOSITION, TONER. AND DISTILLING DEVICE

(71) Applicants: Shunki Katsumata, Shizuoka (JP); Daizaburoh Mizuno, Lawrenceville, GA (US); Natsuko Matsushita, Shizuoka (JP)

(72) Inventors: Shunki Katsumata, Shizuoka (JP); Daizaburoh Mizuno, Lawrenceville, GA (US); Natsuko Matsushita, Shizuoka (JP)

(73) Assignee: Etria Co., Ltd., Kanagawa (JP)

(21) Appl. No.: 19/412,060

(22) Filed: Dec. 8, 2025

(30) Foreign Application Priority Data
Dec. 9, 2024 (JP) 2024-214388

(51) Int. Cl. G03G 9/08; C08J 3/09; G03G 9/09

(52) U.S. Cl. CPC G03G 9/0804; C08J 3/095; G03G 9/09; C08J 2367/08

(57) ABSTRACT

A method of manufacturing resin fine particles includes preparing a resin dispersion containing an organic solvent, water, a resin, and a surfactant and distilling the resin dispersion to remove the organic solvent, wherein the mass ratio of the resin to the surfactant is from 1:1 to 1:2.

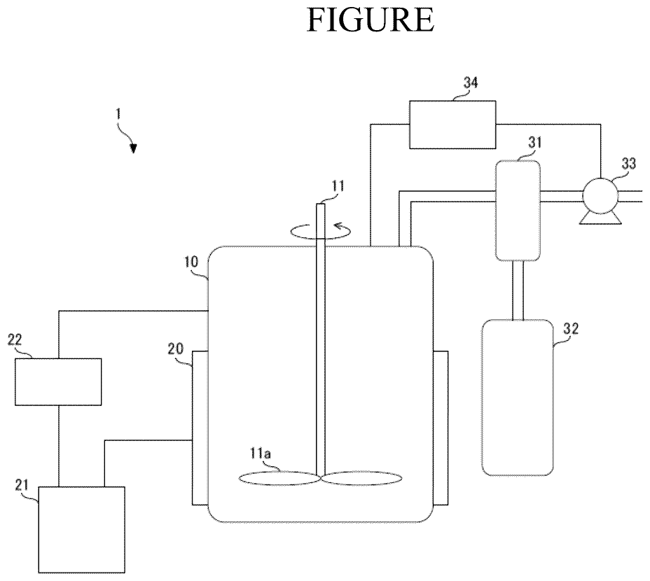

### CROSS-REFERENCE TO RELATED APPLICATIONS

This patent application is based on and claims priority pursuant to 35 U.S.C. § 119 to Japanese Patent Application No. 2024-214388 filed on Dec. 9, 2024, in the Japan Patent Office, the entire disclosure of which is hereby incorporated by reference herein.

### BACKGROUND

### Technical Field

The present disclosure is related to a method of manufacturing resin fine particles, a resin fine particle composition, a toner, and a distilling device.

### Description of the Related Art

In general, in a method of manufacturing resin fine particles, chemical reactions such as emulsification reactions are carried out under temperature control or pressure control so as to produce resin fine particles through processes of recovering the resin fine particles and removing the organic solvent. In the production process, as the reaction proceeds, resin fine particles adhere to the wall surface of the reaction vessel due to mixing of resin fine particles with poor granulation and degraded surface properties, resulting in a problem of reduced yield at the time of recovering the resin fine particles.

In typical methods, during recovery of the organic solvent in the emulsification reaction, the organic solvent and the aqueous medium evaporate, increasing the solid content concentration of the resin fine particles in the liquid. This increased concentration causes adhesion of the resin fine particles to the wall surface of the reaction vessel, resulting in a decrease in the yield of the resin fine particles.

### SUMMARY

The present disclosure described herein provides a method of manufacturing resin fine particles which includes preparing a resin dispersion containing an organic solvent, water, a resin, and a surfactant and distilling the resin dispersion to remove the organic solvent, wherein the mass ratio of the resin to the surfactant is from 1:1 to 1:2.

As another aspect of the present disclosure, a resin fine particle composition is provided which contains resin fine particles each containing a resin that contains a polyester resin, a colorant, a release agent, and a surfactant, wherein the resin fine particle composition has a volume average particle diameter of 10 to 30 μm, the surfactant has a concentration of 500 to 1000 ppm at surfaces of the resin fine particles, the an average value of an intensity ratio (P₂₈₅₀/P₈₂₈) of an absorption spectral peak intensity P₂₈₅₀ at a wavenumber of 2850 cm⁻¹ to an absorption spectral peak intensity P₈₂₈ at a wavenumber of 828 cm⁻¹, as determined by FTIR-ATR mapping, is 0.20 to 0.40 on surfaces of the resin fine particles, and the proportion of the intensity ratio (P₂₈₅₀/P₈₂₈) having at least 0.40 is 10 to 50 percent.

As another aspect of the present disclosure, a toner is provided which contains the resin fire particle composition mentioned above.

As another aspect of the present disclosure, a distilling device is provided which includes a distilling tank that includes a wall, to store a resin dispersion containing an organic solvent, water, a resin, and a surfactant, and a heating device connected to a heat pump to heat the wall, wherein the heating device is capable of changing the temperature and the pressure inside the distilling tank stepwise, and the distilling tank distills the resin dispersion to remove the organic solvent.

### BRIEF DESCRIPTION OF THE VIEW OF THE DRAWING

A more complete appreciation of the disclosure and many of the attended advantages and features thereof can be readily obtained and understood from the following detailed description with reference to the accompanying drawings wherein: The drawing is a schematic diagram illustrating an example of the distilling device.

The accompanying drawing is intended to depict example embodiments of the present invention and should not be interpreted to limit the scope thereof. The accompanying drawing is not to be considered as drawn to scale unless explicitly noted. Also, identical or similar reference numerals designate identical or similar components throughout the view.

### DESCRIPTION OF THE EMBODIMENTS

The terminology used herein is for the purpose of describing particular embodiments only and is not intended to be limiting of the present invention. As used herein, the singular forms “a”, “ ”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more the features, integers, steps, operations, elements, components, and/or groups thereof.

Embodiments of the present invention are described in detail below with reference to accompanying drawings. In describing embodiments illustrates in the drawings, specific terminology is employed for the sake of clarity. However, the disclosure of this patent specification is not intended to be limited to the specific terminology so selected. And it is to be understood that each specific element includes all technical equivalents that have a similar function, operates in a similar manner, and achieve a smaller result.

For the sake of simplicity, the same reference number will be given to identical constituent elements such as parts and materials having the same functions and redundant descriptions thereof omitted unless otherwise stated.

According to the present disclosure, a method of manufacturing resin fine particles that inhibits the adhesion of resin fine particles to the wall surface of the container, which is caused by the inclusion of poorly granulated resin fine particles and resin fine particles with degraded surface properties.

### Method of Manufacturing Resin Fine Particle and Resin Fine Particle Composition

The method of manufacturing the resin fine particle composition (hereinafter also simply referred to as reins fine particles) of the present disclosure includes preparing a liquid resin dispersion (hereinafter also simply referred to as resin dispersion) that contains an organic solvent, water, a resin, and a surfactant, and distilling the resin dispersion to remove the organic solvent. Additional processes may be furthermore optionally included as necessary.

The resin fine particles of the present disclosure are produced by the aforementioned method and exhibit reduced adhesion to the container wall surface. Such adhesion is typically caused by the inclusion of poorly granulated particles and particles exhibiting degraded surface characteristics. Furthermore, the resin fine particles having controlled surface characteristics can be used as constituent materials in toner compositions for developing electrostatic images in electrophotography, electrostatic recording, and electrostatic printing, regardless of the production method, such as polymerization or pulverization. Toners containing these resin fine particles contribute to improved image density. The resin fine particles obtained through the present disclosure, with controlled surface characteristics, are highly useful not only for toners, but also for applications in materials that require resin functionality—such as colorants including paints, inks, recording materials, and textile dyes—as well as applications where surface characteristics affect color reproduction or tactile sensation, such as cosmetics.

### Material for Resin Fine Particle

First, the materials for the resin fine particles will be described. The material of the resin fine particles includes an adhesive base material obtained by reacting a compound containing an active hydrogen group, a polymer capable of reacting with the compound containing an active hydrogen group, a resin, a release agent, and a colorant. Additionally, other components such as a charge control agent may be optionally included.

### Adhesive Base Material

The adhesive base material exhibits adhesion to recording media such as paper, and includes an adhesive polymer obtained by reacting the compound containing an active hydrogen group and the polymer capable of reacting with the compound in an aqueous medium. It may further include a resin appropriately selected from known resins.

The weight average molecular weight of the adhesive base material is not particularly limited and can be appropriately selected to suit to a particular application. It is preferably at least 1,000, more preferably from 2,000 to 10,000,000, and furthermore preferably from 3,000 to 1,000,000. If the weight average molecular weight is less than 1,000, the hot offset resistance property is likely to deteriorate.

There are no particular limitations on the storage modulus of the adhesive base material, and it may be appropriately selected according to a particular application. For example, the temperature (TG′) at which the storage modulus reaches 10,000 dyne/cm² at a measurement frequency of 20 Hz is typically at least 100 degrees Celsius, preferably in the range of 110 to 200 degrees Celsius. If TG′ is below 100 degrees Celsius, hot offset resistance may deteriorate. There are also no particular limitations on the viscosity of the aforementioned adhesive base material, and it may be appropriately selected according to a particular application. For example, the temperature (Tn) at which the viscosity reaches 1,000 poise at a measurement frequency of 20 Hz is typically at most 180 degrees Celsius, preferably in the range of 90 to 160 degrees Celsius.

If Iη exceeds 180 degrees Celsius, low-temperature fixability may deteriorate. Therefore, from the viewpoint of achieving both hot offset resistance and low-temperature fixability, it is preferable that TG′ be higher than Tη. The difference (TG′−Tη) between TG′ and Tη is preferably at least 0 degrees Celsius, more preferably at least 10 degrees Celsius, and even more preferably at least 20 degrees Celsius. A larger difference is preferable. Furthermore, from the viewpoint of achieving both low-temperature fixability and heat storage stability, the difference (TG′−Tη) is preferably in the range of 0 to 100 degrees Celsius, more preferably 10 to 90 degrees Celsius, and even more preferably 20 to 80 degrees Celsius.

As specific examples of the adhesive substrate, there are no particular limitations, and it may be appropriately selected according to a particular application. Polyester-based resins are particularly preferred. As for the polyester-based resin, there are no particular limitations, and it may be appropriately selected according to a particular application. For example, urea-modified polyester-based resins are particularly preferred. The aforementioned urea-modified polyester-based resin can be obtained by reacting an amine compound (B), which serves as the active hydrogen-containing compound, with an isocyanate group-containing polyester prepolymer (A), which serves as a polymer capable of reacting with the active hydrogen-containing compound, in the aqueous medium. The urea-modified polyester-based resin may contain urethane bonds along with urea bonds. In this case, the molar ratio of the urea bonds to the urethane bonds (urea bonds/urethane bonds) is not particularly limited and may be appropriately selected according to a particular application. A ratio of 100/0 to 10/90 is preferable, 80/20 to 20/80 is more preferable, and 60/40 to 30/70 is even more preferable. If the content of urea bonds is less than 10, the hot offset resistance may deteriorate.

Preferred specific examples of the urea-modified polyester resin include, but are not limited to, the following (1) to (10):
(1) A mixture of (i) and (ii): (i) a polyester prepolymer obtained by reacting a condensation product of an adduct of bisphenol A with 2 mols of ethylene oxide and isophthalic acid with isophorone diisocyanate, followed by urea modification with isophorone diamine, and (ii) a condensation product of an adduct of bisphenol A with 2 mols of ethylene oxide and isophthalic acid.
(2) A mixture of (i) and (ii): (i) a polyester prepolymer obtained by reacting a condensation product of an adduct of bisphenol A with 2 mols of ethylene oxide and isophthalic acid with isophorone diisocyanate, followed by urea modification with isophorone diamine, and (ii) a condensation product of an adduct of bisphenol A with 2 mols of ethylene oxide and terephthalic acid.
(3) A mixture of (i) and (ii): (i) a polyester prepolymer obtained by reacting a condensation product of an adduct of bisphenol A with 2 mols of ethylene oxide/an adduct of bisphenol A with 2 mols of propylene oxide and terephthalic acid with isophorone diisocyanate, followed by urea modification with isophorone diamine, and (ii) a condensation product of an adduct of bisphenol A with 2 mols of ethylene oxide/an adduct of bisphenol A with 2 mols of propylene oxide and terephthalic acid.
(4) A mixture of (i) and (ii): (i) a polyester prepolymer obtained by reacting a condensation product of an adduct of bisphenol A with 2 mols of ethylene oxide/an adduct of bisphenol A with 2 mols of propylene oxide and terephthalic acid with isophorone diisocyanate, followed by urea modification with isophorone diamine, and (ii) a condensation product of an adduct of bisphenol A with 2 mols of propylene oxide and terephthalic acid.
(5) A mixture of (i) and (ii): (i) a polyester prepolymer obtained by reacting a condensation product of an adduct of bisphenol A with 2 mols of ethylene oxide and terephthalic acid with isophorone diisocyanate, followed by urea modification with hexamethylenediamine, and (ii) a condensation product of an adduct of bisphenol A with 2 mols of ethylene oxide and terephthalic acid.
(6) A mixture of (i) and (ii): (i) a polyester prepolymer obtained by reacting a condensation product of an adduct of bisphenol A with 2 mols of ethylene oxide and terephthalic acid with isophorone diisocyanate, followed by urea modification with hexamethylenediamine, and (ii) a condensation product of an adduct of bisphenol A with 2 mols of ethylene oxide/an adduct of bisphenol A with 2 mols of propylene oxide and terephthalic acid.
(7) A mixture of (i) and (ii): (i) a polyester prepolymer obtained by reacting a condensation product of an adduct of bisphenol A with 2 mols of ethylene oxide and terephthalic acid with isophorone diisocyanate, followed by urea modification with ethylenediamine, and (ii) a condensation product of an adduct of bisphenol A with 2 mols of ethylene oxide and terephthalic acid.
(8) A mixture of (i) and (ii): (i) a polyester prepolymer obtained by reacting a condensation product of an adduct of bisphenol A with 2 mols of ethylene oxide and isophthalic acid with diphenylmethane diisocyanate, followed by urea modification with hexamethylenediamine, and (ii) a condensation product of an adduct of bisphenol A with 2 mols of ethylene oxide and isophthalic acid.
(9) A mixture of (i) and (ii): (i) a polyester prepolymer obtained by reacting a condensation product of an adduct of bisphenol A with 2 mols of, but are not limited ethylene oxide/an adduct of bisphenol A with 2 mols of propylene oxide and terephthalic acid/dodecenylsuccinic anhydride with diphenylmethane diisocyanate, followed by urea modification with hexamethylenediamine, and (ii) a condensation product of an adduct of bisphenol A with 2 mols of ethylene oxide/an adduct of bisphenol A with 2 mols of propylene oxide and terephthalic acid.
(10) A mixture of (i) and (ii): (i) a polyester prepolymer obtained by reacting a condensation product of an adduct of bisphenol A with 2 mols of ethylene oxide and isophthalic acid with toluene diisocyanate, followed by urea modification with hexamethylenediamine, and (ii) a condensation product of an adduct of bisphenol A with 2 mols of ethylene oxide and isophthalic acid.

### Compound Having Active Hydrogen Group

The compound having an active hydrogen group serves as a chain extender or crosslinking agent during extension and crosslinking reactions of polymers reactive with the active hydrogen groups of the compound in an aqueous medium. Any known compound containing an active hydrogen group can be used and may be appropriately selected according to a particular application. For example, amines (B) are preferable when the polymer reactive with the active hydrogen groups is a polyester prepolymer (A) having an isocyanate group, because the resulting polymer potentially achieves a high molecular weight through extension and crosslinking reactions with the isocyanate group of the polyester prepolymer (A). The active hydrogen group is not particularly limited and may be appropriately selected according to a particular application.

Specific examples include, but are not limited to, hydroxyl groups, such as alcoholic hydroxyl groups or phenolic hydroxyl groups, amino groups, carboxyl groups, and mercapto groups.

These can be used alone or in combination. Of these, alcoholic hydroxyl groups are particularly preferable.

The amines (B) are not particularly limited and may be suitably selected according to a particular application.

Specific examples include, but are not limited to: diamines (B1); polyamines (B2) having three or more amino groups; amino alcohols (B3); amino mercaptans (B4); amino acids (B5); and blocked amines (B6), in which the aforementioned amines (B1 to B5) are blocked. These can be used alone or in combination. Among these, diamines (B1), as well as mixtures of diamines (B1) with a small amount of polyamines (B2) having three or more amino groups, are particularly preferred.

Specific examples of the diamines (B1) include, but are not limited to, aromatic diamines, alicyclic diamines, and aliphatic diamines.

Specific examples of the aromatic diamines include, but are not limited to, phenylene diamines, diethyl toluene diamines, and 4,-4′-diamino diphenyl methane. Specific examples of the alicyclic diamines include, but are not limited to, 4,4′-diamino-3,3-dimethyl dicyclohexyl methane, diaminocyclohexane, and isophoron diamine.

Specific examples of the aliphatic diamines include, but are not limited to, ethylene diamine, tetramethylene diamine, and hexamethylene diamine.

Specific examples of the polyamines (B2) having three or more amino groups include, but are not limited to, diethylene triamine, and triethylene tetramine.

Specific examples of the amino alcohols (B3) include, but are not limited to, ethanol amine and hydroxyethyl aniline.

Specific examples of the amino mercaptan (B4) include, but are not limited to, aminoethyl mercaptan and aminopropyl mercaptan.

Specific examples of the amino acids (B5) include, but are not limited to, amino propionic acid and amino caproic acid.

Specific examples of the blocked amines (B6) include, but are not limited to, ketimine compounds which are prepared by reacting one of the amines (B1) to (B5) mentioned above with a ketone such as acetone, methyl ethyl ketone and methyl isobutyl ketone, oxazoline compounds, etc.

A reaction terminator may be used to terminate the extension reaction, cross-linking reaction, or other reactions between a compound having an active hydrogen group and a polymer reactive with such a compound. By using a reaction terminator, the molecular weight and other properties of the adhesive base material can be controlled within a desired range.

Specific preferred examples of molecular weight control agents include, but are not limited to, monoamines (e.g., diethylamine, dibutylamine, butylamine, and laurylamine) that do not contain active hydrogen groups, and blocked amines (i.e., ketimine compounds) obtained by blocking the aforementioned monoamines.

The mixing ratio of the isocyanate groups to the amines (B)—i.e., the equivalent ratio ([NCO]/[NHx]) of the isocyanate groups [NCO] in the prepolymer (A) to the amino groups [NHx] in the amines (B)—is preferably in the range of 1:3 to 3:1, more preferably 1:2 to 2:1, and particularly preferably exactly 1:1.5 to 1.5:1. When the equivalent ratio ([NCO]/[NHx]) is less than 1:3, the low-temperature fixing performance may be reduced. Conversely, when the ratio exceeds 3:1, the molecular weight of the resulting urea-modified polyester resin tends to decrease, which may lead to deterioration in hot offset resistance.

Polymer Reactive with Compound Having Active Hydrogen Group

Any known polymer having at least a portion reactive with a compound having an active hydrogen group (hereinafter referred to as prepolymer) can be suitably used as the polymer reactive with the compound having an active hydrogen group and it can be suitably selected from known resins.

Specific examples include, but are not limited to, polyol resins, polyacrylic resins, polyester resins, epoxy resins, and derivatives thereof. These can be used alone or in combination. Of these, polyester resins are particularly preferable in terms of high fluidity and transparency during melting.

The portion of the prepolymer that is reactive with a compound having an active hydrogen group is not particularly limited and may be suitably selected from known substituent groups.

Specific examples include, but are not limited to, isocyanate groups, epoxy groups, carboxylic acids, and acid chloride groups. These can be used alone or in combination. Among these, isocyanate group is particularly preferable.

Among the prepolymers, polyester resins containing a urea-bond-forming group (RMPE) are particularly preferred, as they provide oil-free low-temperature fixing properties in toner compositions. In particular, they exhibit excellent release characteristics and fixability, even in the absence of a release oil application mechanism to a heating medium used for fixing. A specific example of the urea-bond producing group is isocyanate group. When the urea-bond-forming group in the polyester resin (RMPE) is an isocyanate group, polyester prepolymers (A) containing isocyanate groups are particularly preferable as the polyester resin (RMPE).

The polyester prepolymer (A) containing an isocyanate group is not particularly limited and may be suitably selected according to a particular application.

One example is a polycondensate of a polyol (PO) and a polycarboxylic acid (PC), obtained by reacting a polyester resin having an active hydrogen group with a polyisocyanate (PIC).

There is no specific limitation on polyol (PO) and it can be suitably selected to a particular application. Examples are diol (DIO), tri- or higher alcohol (TO), and a mixture of a polyol (TO) and a diol (DIO). These can be used alone or in combination. Among these, a simple diol (DIO) or a mixture in which a small amount of a triol (TO) or higher polyol is mixed with a diol (DIO) is preferable.

Specific examples of diol (DIO) include, but are not limited to, alkylene glycol, alkylene etherglycol, alicyclic diols, adducts of alicyclic diol with alkylene oxide, bisphenols, and adducts of bisphenol with alkylene oxide. As alkylene glycol, articles having 2 to 12 carbon atoms are preferable.

Specific examples include, but are not limited to, ethylene glycol, 1,2-propylene glycol, 1,3-propylene glycol, 1,4-butanediol, and 1,6-hexanediol.

Specific examples of the alkylene ether glycol include, but are not limited to, diethylene glycol, triethylene glycol, dipropylene glycol, polyethylene glycol, polypropylene glycol, and polytetramethylene ether glycol.

Specific examples of the alicyclic diols include, but are not limited to, 1,4-cyclohexane dimethanol and hydrogenated bisphenol A.

Specific examples of the adducts of alycyclic diol with alkylene oxides include, but are not limited to, adducts of alicyclic diol with alkylene oxides such as ethylene oxide, propylene oxide, and butylene oxide. Specific examples of bisphenol include, but are not limited to, bisphenol A, bisphenol F, and bisphenol S.

Specific examples of the adducts of bisphenol with alkylene oxides include, but are not limited to, adducts of bisphenols with alkylene oxides such as ethylene oxide, propylene oxide, and butylene oxide. Of these, alkylene glycol having 2 to 12 carbon atoms or adducts of bisphenols with alkylene oxide are preferable. An adduct of a bisphenol with an alkylene oxide and a mixture of an adduct of a bisphenol with an alkylene oxide and an alkylene glycol having a 2 to 12 carbon atoms are particularly preferable.

As the polyols (1-2) having three or more alcohol groups, polyols having three to eight or more alcohol groups are preferable.

Specific examples include, but are not limited to, polyaliphatic alcohols having three or more alcohol groups, polyphenols having three or more alcohol groups, and adducts of the polyphenols having three or more alcohol groups with an alkylene oxide.

Specific examples of the polyaliphatic alcohols having three or more hydroxyl groups include, but are not limited to, glycerin, trimethylol ethane, trimethylol propane, pentaerythritol, and sorbitol.

Specific examples of ti- or higher polyphenol include, but are not limited to, trisphenol PA, phenol novolac, and cresol novolac.

Specific examples of the adducts of polyphenols having three or more hydroxyl groups with alkylene oxides include, but are not limited to, adducts of polyphenols having three or more hydroxyl groups with alkylene oxides such as ethylene oxide, propylene oxide, and butylene oxide.

The mixing ratio in mass of diol (DIO) to polyol (TO) having three or more hydroxyl groups in the mixture of diol (DIO) and polyol (TO) having three or more hydroxyl groups is preferably from 100:001 to 10 and more preferably from 100:0.01 to 1.

There is no specific limitation to polcarboxylic acid (PC) and it can be suitably selected to a particular application.

Examples are dicarboxylic acid (DIC), polycarboxylic acid (TC) having three or more carboxylic groups, and a mixture of dicarboxylic acid (DIC) and polycarboxylic acid (TC) having three or more carboxylic groups.

These can be used alone or in combination. Of these, a simple dicarboxylic acid (DIC) or a mixture in which a small amount of tricarboxylic acid (TC) or carboxylic acid having three or more carboxylic groups is mixed with a dicarboxylic acid (DIC) is preferable.

Specific examples of the dicarboxylic acid (DIC) include, but are not limited to, alkylene dicarboxylic acid, alkylene dicarboxylic acid, and an aromatic dicarboxylic acid.

Specific examples of the alkylene dicarboxylic acid include, but are not limited to, succinic acid, adipic acid, and sebacic acid. In particular, alkenylene dicarboxylic acid having 4 to 20 carbon atoms are preferable.

Specific examples include, but are not limited to, maleic acid and fumaric acid. Also, aromatic dicarboxylix acids having 4 to 20 carbon atoms are preferable.

Specific examples include, but are not limited to phthalic acid, isophhtalic acid, terephthalic acid, and naphthalene dicarboxylic acid. Among these, alkenylene dicarboxylic acids having 4 to 20 carbon atoms and aromatic dicarboxylic acids having 8 to 20 carbon atoms are preferable.

Polyols polycarboxylic acid having three to eight or more carboxylic groups are preferable. For example, aromatic polycarboxylic acids are preferable. In addition, aromatic polycarboxylic acid having 9 to 20 carbon atoms are preferable.

Specific examples include, but are not limited to, trimellitic acid and pyromellitic acid.

As the polycarboxylic acid (PC), it is also possible to use an acid anhydride or a lower alkyl ester of any of the following: the above-mentioned dicarboxylic acid (DIC), the above-mentioned polycarboxylic acid having a valency of three or more (TC), or a mixture of the dicarboxylic acid (DIC) and the polycarboxylic acid (TC).

Specific examples of the lower alkyl esters include, but are not limited to, methyl esters, ethyl esters, and isopropyl esters.

The mixing ratio (DIC:TC) in mass of dicarboxylic acid (DIC) to polycarboxylic acid (TC) having three or more carboxylic groups in the mixture of dicarboxylic acid (DIC) and polycarboxylic acid (TC) having three or more carboxylic groups has no particular limit and can be suitably selected to suit to a particular application. For example, it is preferably from 100:001 to 10 and more preferably from 100:0.01 to 1.

The mixing ratio of the polyol (PO) and the polycarboxylic acid (PC) mentioned above in polycondensation reaction has no particular limit and can be suitably selected to suit to a particular application. For example, the equivalent ratio ([OH]/{COOH}) of hydroxyl group [OH} in the polyol (PO) to carboxyl group {COOH} in the polycarboxylic acid (PC) is preferably from 2/1 to 1/1, more preferably from 1.5/1 to 1/1, and particularly preferably from 1.3/1 to 1.02/1.

There is no specific limit to the content of the polyol (PO) in the polyester prepolymer (A) having an isocyanate group and it can be suitably selected to suit to a particular application. For example, the proportion is preferably from 0.5 to 40 percent by mass, more preferably from 1 to 30 percent by mass, and particularly preferably from 2 to 20 percent by mass. When the proportion is less than 0.5 percent by mass, hot offset resistance may deteriorate, which causes a trade-off between heat resistance storage property and low temperature fixability. Conversely, when the proportion is greater than 40 percent by mass, low temperature fixability of the toner easily deteriorates.

The polyisocyanate (PIC) mentioned above have no particular limit and can be suitably selected to suit to a particular application. Aliphatic polyisocyanates, alicyclic polyisocyanates, aromatic diisoycantes, aromatic aliphatic diisocyanates, isocyanurates, phenol derivatives thereof, and blocked polyisocyanates in which the polyisocyanates mentioned above are blocked with oximes or caprolactams.

Specific examples of the aliphatic polyisocyanates include, but are not limited to, tetramethylene diisocyanate, hexamethylene diisocyanate, 2,6-diisocyanate methylcaproate, octamethylene diisocyanate, decamethylene diisocyanate, dodecamethylene diisocyanate, tetradecamethylene diisocyanate, trimethyl hexane diisocyanate, and tetramethyl hexane diisocyanate. Specific examples of the alicyclic diisocyanate include, but are not limited to, isophorone diisocyanate and cyclohexylmethane diisocyanate.

Specific examples of the aromatic diisoycantes include, but are not limited to, tolylene diisocyanate, diphenylmethane diisocyanate, 1,5-naphthylene diisocyanate, diphenylene-4,4′-disocyanate, 4,4-diisocyanate-3,3′-dimethyldiphenyl, 3-methyl diphenylmethane-4,4′-diisocyanate, and diphenyl ether-4,4′-diisocyanate. One specific example of the aromatic aliphatic diisocyanates is a, a, a′, a′-tetramethyl xylylene diisocyanate.

Specific examples of the isocyanurates include, but are not limited to, tris-isocyanate alkyl-isocyanulate, and triisocyanate cycloalkyl-isocyanulate. These can be used alone or in combination.

The mixing ratio of the polyisocyanate (PIC) and the polyester resin having an active hydrogen group (for example, polyester resin having a hydroxyl group) in the reaction thereof is that the mixing equivalent ratio ([NCO]/[OH]) of isocyanate group [NCO] in the polyisocyanate (PIC) to hydroxyl group [OH] in the polyester resin having a hydroxyl group is preferably from 5/1 to 1/1, more preferably from 4/1 to 1.2/1, and particularly preferably from 3/1 to 1.5/1. When the mixing equivalent ratio of the isocyanate group [NCO] surpasses 5, low temperature fixability may deteriorate. Conversely, when it is less than 1, offset resistance tends to deteriorate.

There is no specific limit to the proportion of the polyisocyanate (PIC) in the polyester prepolymer (A) having an isocyanate group and it can be suitably selected to suit to a particular application. For example, the proportion is preferably from 0.5 to 40 percent by mass, more preferably from 1 to 30 percent by mass, and particularly preferably from 2 to 20 percent by mass. When the proportion is less than 0.5 percent by mass, hot offset resistance may deteriorate, which causes a trade-off between heat resistance storage property and low temperature fixability. Conversely, when the proportion is greater than 40 percent by mass, low temperature fixability of the toner easily deteriorates.

In addition, the average number of the isocyanate groups per molecule of the polyester prepolymer (A) having an isocyanate group is preferably 1 or more, more preferably from 1.2 to 5, and furthermore preferably from 1.5 to 4. When the average number is less than 1, the molecular weight of polyester resin (RMPE) modified by a urea-bond producing group decreases, which may lead to deterioration of hot offset resistance.

The mass average molecular weight (Mw) of the polymer reactive with the compound having an active hydrogen group is preferably from 1,000 to 30,000 and more preferably from 1,500 to 15,000 in the molecular weight distribution by gel permeation chromatography (GPC) of portion soluble in tetrahydrofuran. When the mass average molecular weight (Mw) is less than 1,000, high temperature storage stability tends to deteriorate. When the mass average molecular weight (Mw) is greater than 30,000, low temperature fixability tends to deteriorate.

The molecular weight distribution by the gel permeation chromatography (GPC) can be measured by, for example, the following method. That is, a column is stabilized in a heat chamber at 40 degrees Celsius. At this temperature, tetrahydrofuran (THF) is used as the column solvent and is flowed at a rate of 1 mL per minute. A THF sample solution of the resin, with the sample concentration adjusted to 0.05 to 0.6 mass percent, is injected in an amount of 50 to 200 μL for measurement. In measuring the molecular weight of the sample toner, the molecular weight distribution of the sample is calculated according to the relationship between the number of counts and the logarithm values of the calibration curve created from several types of the monodispersed polystyrene reference samples. As the standard polystyrene sample for the calibration curve, it is preferable to use at least about ten standard polystyrene samples using, for example, polystyrene samples having a molecular weight of 6×10², 2.1×10², 4×10², 1.75×10⁴, 1.1×10⁵, 3.9×10⁵, 8.6×10⁵, 2×10⁶, and 4.48×10⁶, manufactured by TOSOH CORPORATION or Pressure Chemical Co. A refractive index (RI) detector can be used as detector.

### Resin

There is no specific limitation on the resin and it can be suitably selected according to a particular application.

Specific examples include, but are not limited to, polyester resins; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-a-methyl chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, and paraffin waxes.

These can be used alone or in combination. Among these, polyester resins are particularly preferable due to their high solubility in organic solvents.

Polyester resins are obtained by condensation polymerization of an alcohol and a carboxylic acid.

Specific examples of such alcohols include, but are not limited to, glycols such as ethylene glycol, diethylene glycol, triethylene glycol, and propylene glycol, 1,4-bis(hydroxymethyl)cyclohexane, etherified bisphenols such as bisphenol A, diol monomers, tri- or higher polyol monomers.

Specific examples of the carboxylic acid include, but are not limited to, di-valent organic acid monomers such as maleic acid, fumaric acid, phthalic acid, isophthalic acid, terephthalic acid, succinic acid, and malonic acid; and tri- or higher carboxylic acid monomers such as 1,2,4-benzene tricarboxylic acid, 1,2,5-benzene tricarboxylic acid, 1,2,4-cyclohexane tricarboxylic acid, 1,2,4-naphthalene tricarboxylic acid, 1,2,5-hexane tricarboxylic acid, 1,3-dicarboxyl-2-methylene carboxy propane, and 1,2,7,8-octane tetracarboxylic acid.

### Colorant

As the colorant, there is no particular limitation, and it may be appropriately selected according to a particular application from known dyes and pigments.

Specific examples include, but are not limited to, carbon black, Naphthol Yellow S, cadmium red, phthalocyanine blue, cobalt violet, and chrome green. These can be used alone or in combination.

The proportion of the colorant is not particularly limited and can be suitably selected to suit to a particular application. For example, it is preferably from 1 to 15 percent by mass and more preferably from 3 to 10 percent by mass. If the content is less than 1 percent by mass, the coloring power of the toner tends to decrease. On the other hand, if it exceeds 15 percent by mass, the pigment may be poorly dispersed in the toner, potentially resulting in reduced coloring power and deterioration of the toner's electrical properties.

The colorant and the resin can be used in combination as a master batch. There is no specific limitation to the resin and it can be suitably selected according to a particular application from known resins.

Specific examples include, but are not limited to, polyester resins, styrene or substituted polymers thereof, styrene-based copolymers, polymethyl methacrylate resins, polybutyl methacrylate resins, polyvinyl chloride resins, polyvinyl acetate resins, polyethylene resins, polypropylene resins, epoxy resins, epoxy polyol resins, polyurethane resins, polyamide resins, polyvinyl butyral resins, polyacrylic resins, rosin, modified rosins, terpene resins, aliphatic hydrocarbon resins, alicyclic hydrocarbon resins, aromatic petroleum resins, chlorinated paraffin, and paraffin wax. These can be used alone or in combination.

Specific examples of polymers of styrene or its substitution products include, but are not limited to, polyester resins, polystyrene, poly(p-chlorostyrene), and polyvinyl toluene.

Specific examples of the styrene-based copolymers include, but are not limited to, styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-a-methyl-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, and styrene-maleic acid ester copolymers.

The master batch can be prepared by mixing and kneading the resin for the master batch resin mentioned above and the coloring agent mentioned above upon application of high shear stress thereto. In this case, an organic solvent is preferably used to boost the interaction between the colorant and the resin. In addition, so-called flushing methods are advantageous in that drying may be omitted, since a wet cake of the coloring agent can be used as is. The flushing method involves mixing or kneading an aqueous paste of the colorant, which contains water, with a resin and an organic solvent, thereby transferring the colorant to the resin phase and removing the water and organic solvent components. High-shear dispersion devices, such as a three-roll mill, can be suitably used for mixing or kneading.

### Release Agent

The release agent is not particularly limited and may be suitably selected according to a particular application from known agents, such as waxes. Examples of the above-mentioned waxes include, but are not limited to, carbonyl group-containing waxes, polyolefin waxes, and long-chain hydrocarbons. These can be used alone or in combination. Among these waxes, the waxes including a carbonyl group are particularly preferable.

Specific examples of the waxes including a carbonyl group include, but are not limited to, polyalkane acid ester, polyalkanol ester, polyalkane acid amide, polyalkyl amide, and dialkyl ketone.

Specific examples of the polyalkane acid esters include, but are not limited to, carnauba wax, montan wax, trimethylol propane tribehenate, pentaerythritol tetrabehenate, pentaerythritol diacetate dibehenate, glycerin tribehenate, and 1,18-octadecanediol distearate.

Specific examples of the polyalkanol esters include, but are not limited to, trimellitic acid tristearyl and distearyl maleate. One specific example of the polyalkane acid amide is dibehenyl amide. One specific example of the polyalkyl amide is trimellitic acid tristearyl amide. One specific example of the dialkyl ketone is distearyl ketone. Among these waxes including a carbonyl group, polyalkane acid esters are particularly preferable.

Specific examples of the polyolefin waxes include, but are not limited to, polyethylene waxes, and polypropylene waxes.

Specific examples of the long-chain hydrocarbons include, but are not limited to, paraffin wax and sazol wax.

There is no specific limit to the melting point of the release agent. The melting point is preferably from 40 to 160 degrees Celsius, more preferably from 50 to 120 degrees Celsius, and particularly preferably from 60 to 90 degrees Celsius. If the melting point of the release agent is below 40 degrees Celsius, it may adversely affect storage stability in high temperature storage stability, and if it exceeds 160 degrees Celsius, cold offset can easily occur during low-temperature fixing. The release agent preferably has a melt viscosity of from 5 cps to 1,000 cps and more preferably from 10 cps to 100 cps at a temperature 20 degrees Celsius higher than the melting point of the wax (release agent). When the melt viscosity is lower than 5 bps, the releasing property may deteriorate. When the melt viscosity is greater than 1,000 cps, effect of improving hot offset resistance and low temperature fixing property may not be obtained.

The proportion of the release agent is not particularly limited and can be suitably selected depending on a particular application. For example, it is preferably from 0 to 40 percent by mass and more preferably from 3 to 30 percent by mass. A proportion of the release agent exceeding 40 percent by mass may degrade flowability of the toner. The intensity ratio of absorption spectral peaks on the surfaces of the resin fine particles by FTIR-ATR mapping and the proportion of their ratios are measurable by the following method.

Measurement of Absorption Spectral Peak Intensity Ratio on Surface of Resin Fine Particles by FTIR-ATR Mapping and Proportion of their Ratios

Three grams of the resin fine particles are pressed for one minute under a load of 6 tons using an automatic pellet molding machine Type M No. 50 BRP-E (manufactured by MAEKAWA TESTING MACHINE) to prepare a pellet. Using the Spotlight 400 infrared imaging system (manufactured by Perkin Elmer), FTIR-ATR mapping was performed on a toner pellet with a diameter of 40 mm and a thickness of approximately 2 mm under the conditions of a measurement area of 50 μm×50 μm and a pixel size of 1.56 μm×1.56 μm (1024 divisions). From this mapping, the absorption spectral peak intensity P₈₂₈ at a wavenumber of 828 cm⁻¹ and the absorption spectral peak intensity P₂₈₅₀ at a wavenumber of 2850 cm⁻¹ are obtained. P₈₂₈ is the peak intensity derived from the resin, and P₂₈₅₀ is the peak intensity derived from the release agent. Therefore, the intensity ratio (P₂₈₅₀/P₈₂₈) represents the relative amount of release agent near the surface of the resin fine particles.

It is preferable that the average value of the intensity ratio (P₂₈₅₀/P₈₂₈), as determined by FTIR-ATR mapping, be between 0.20 and 0.40, and more preferably between 0.25 and 0.35. If the average value of the intensity ratio (P₂₈₅₀/P₈₂₈) is less than 0.20, hot offset resistance deteriorates. If it exceeds 0.40, the yield decreases due to adhesion to the reaction vessel wall. It is preferable that the proportion of the intensity ratio (P₂₈₅₀/P₈₂₈) having at least 0.40 is between 10 percent and 50 percent, and more preferably between 25 percent and 35 percent. If the proportion is less than 10 percent, hot offset resistance deteriorates. If it exceeds 50 percent, the yield decreases due to adhesion to the reaction vessel wall. The average value of the intensity ratio (P₂₈₅₀/P₈₂₈) is measured at an infrared incident angle of 41.5 degree, with a resolution of 4 cm⁻¹ and 20 accumulations. The intensity ratio (P₂₈₅₀/P₈₂₈) is determined based on the average value obtained from a hundred measurements.

### Charge Control Agent

There is no particular limitation on the charge control agent, and any known agent is appropriately selected depending on the intended purpose. Since colored materials affect the tone or appearance, colorless or nearly white materials are preferable.

Specific examples of charge control agents include, but are not limited to, triphenylmethane dyes, molybdic acid chelate pigments, Rhodamine dyes, alkoxyamines, quaternary ammonium salts (including fluorine-modified quaternary ammonium salts), alkylamides, elemental phosphorus or its compounds, elemental tungsten or its compounds, fluorine-based surfactants, metal salts of salicylic acid, and metal salts of salicylic acid derivatives. These can be used alone or in combination. The aforementioned charge control agent is a commercially available product.

Specific examples include, but are not limited to, Bontron P-51, a quaternary ammonium salt; E-82, a metal complex of oxynaphthoic acid; E-84, a metal complex of salicylic acid; and E-89, a phenolic condensate (all manufactured by ORIENT CHEMICAL INDUSTRIES CO., LTD.); TP-302 and TP-415, molybdenum complexes of quaternary ammonium salts (both manufactured by HODOGAYA CHEMICAL CO., LTD.); Copy Charge PSYVP2038, a quaternary ammonium salt; Copy Blue PR, a triphenylmethane derivative; Copy Charge NEGVP2036 and Copy Charge NXVP434, both quaternary ammonium salts (all manufactured by Hoechst AG); LRA-901 and LR-147, a boron complex (manufactured by JAPAN CARLIT CO., LTD.); quinacridone, azo-based pigments, and other polymer compounds having functional groups such as sulfonic acid groups, carboxyl groups, and quaternary ammonium salts. The aforementioned charge control agent may be dissolved or dispersed after being melt-kneaded together with the masterbatch, or it may be added during the process of directly dissolving or dispersing the components of the resin particles in the organic solvent. Alternatively, it may be fixed onto the surface of the resin particles after their production.

The content of the charge control agent depends on factors such as the type of the resin, the presence of additives, and the dispersion method. Therefore, it cannot be strictly regulated. For example, the content is preferably from 0.1 to 10 parts by mass, and more preferably from 0.2 to 5 parts by mass, per 100 parts by mass of the resin. If the content is less than 0.1 parts by mass, sufficient charge control may not be achieved. On the other hand, if the content exceeds 10 parts by mass, the chargeability may become excessively high, which can reduce the effectiveness of the primary charge control agent and potentially lead to a decrease in fluidity.

### Other Optional Components

There are no particular limitations on the other components.

Specific examples include, but are not limited to, inorganic particles, flowability enhancer, cleaning improvers, magnetic materials, metal soaps, and emulsifying agents.

Any known inorganic fine particle is suitably selected.

Specific examples include, but are not limited to, silica, alumina, titanium oxide, barium titanate, magnesium titanate, calcium titanate, strontium titanate, zinc oxide, tin oxide, quartz sand, clay, mica, slaked lime, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. These can be used alone or in combination. The inorganic particulate preferably has a primary particle diameter of from 5 nm to 2 μm, and more preferably from 5 nm to 500 nm. In addition, the specific surface area of such inorganic particulates measured by a BET method is preferably from 20 to 500 m²/g. The content of the inorganic fine particles is preferably from 0.01 to 5.0 percent by mass, and more preferably from 0.01 to 2.0 percent by mass.

The flowability enhancer refers to a substance that has undergone surface treatment to enhance hydrophobicity, thereby preventing deterioration in the flow characteristics and chargeability of the toner composition even under high humidity conditions.

Specific examples include, but are not limited to, silane coupling agents, silylating agents, silane coupling agents having fluorinated alkyl groups, organic titanate coupling agents, aluminum-based coupling agents, silicone oils, and modified silicone oils.

Specific examples of the cleaning improver include, but are not limited to, metal salts of fatty acids such as zinc stearate, calcium stearate, and stearic acid, as well as polymer particles produced by soap-free emulsion polymerization, such as polymethyl methacrylate fine particles and polystyrene fine particles. The polymeric fine particles preferably have a relatively narrow particle size distribution and the volume average particle diameter thereof is preferably from 0.01 μm to 1 μm. There are no particular limitations on the magnetic material and the material can be suitably selected according to a particular application from known materials.

Specific examples of the magnetic material include, but are not limited to, oxidized iron such as magnetite, hematite and ferrite, metals such as iron, cobalt and nickel, or an alloyed metal thereof with aluminum, cobalt, copper, lead, magnesium, tin, zinc, antimony, beryllium, bismuth, cadmium, calcium, manganese, selenium, titanium, tungsten and vanadium, and a mixture thereof. Among these, magnetite is preferable in terms of magnetic characteristics. These strong magnetic materials preferably have an average particle diameter ranging from 0.1 to 2 μm. The content of these materials in the toner composition is preferably from 15 to 200 parts by mass, and more preferably from 20 to 100 parts by mass, based on 100 parts by mass of the resin.

As the emulsifying agent, any resin capable of forming an aqueous dispersion in a water-based medium is used without particular limitation. A known resin may be appropriately selected depending on a particular application, and may be either a thermoplastic resin or a thermosetting resin.

Examples include, but are not limited to, vinyl resins, polyurethane resins, epoxy resins, polyester resins, polyamide resins, polyimide resins, silicone resins, phenolic resins, melamine resins, urea resins, aniline resins, ionomer resins, and polycarbonate resins. Among these, vinyl resins are particularly preferred. These can be used alone or in combination. Among these resins, it is preferable to use at least one selected from vinyl resins, polyurethane resins, epoxy resins, and polyester resins, as they readily yield an aqueous dispersion containing fine spherical particles.

Specific examples of the vinyl resins include, but are not limited to, polymers, which are prepared by polymerizing a vinyl monomer or copolymerizing vinyl monomers, such as styrene-(meth)acrylate resins, styrene-butadiene copolymers, (meth)acrylic acid-acrylate copolymers, styrene-acrylonitrile copolymers, styrene-maleic anhydride copolymers, and styrene-(meth)acrylic acid copolymers.

As the emulsifying agent, it is also possible to use a copolymer containing a monomer having at least two unsaturated groups. There are no particular limitations on the monomer having at least two unsaturated groups, and it is appropriately selected according to a particular application.

Specific examples include, for instance, sodium salt of ethylene oxide adduct of methacrylic acid sulfate ester (Eleminol RS-30, manufactured by Sanyo Chemical Industries, Ltd.), divinylbenzene, and 1,6-hexanediol acrylate.

The emulsifying agent is obtained by polymerizing a known resin appropriately selected according to a particular application, using a known method. Preferably, it is obtained in the form of an aqueous dispersion of the emulsifying agent. Examples of methods of preparing the aqueous dispersion of the emulsifying agent include:
(1) in the case of vinyl resins, a method of directly producing an aqueous dispersion of resin particles by polymerizing vinyl monomers via a polymerization reaction selected from suspension polymerization, emulsion polymerization, seed polymerization, or dispersion polymerization;
(2) in the case of addition or condensation-type resins such as polyester resins, polyurethane resins, or epoxy resins, a method of dispersing a precursor (e.g., monomer or oligomer) or its solution in a water-based medium in the presence of a suitable dispersant, followed by heating or addition of a curing agent to cure the resin and obtain an aqueous dispersion of the emulsifying agent;
(3) in the case of addition or condensation-type resins such as polyester resins, polyurethane resins, or epoxy resins, a method of dissolving a suitable emulsifying agent in a precursor or its solvent solution (preferably in liquid form, or liquefied by heating), followed by phase inversion emulsification by adding water;
(4) a method of pulverizing a resin prepared in advance by any polymerization reaction (e.g., addition polymerization, ring-opening polymerization, polyaddition, addition-condensation, or condensation polymerization) using a mechanical rotary or jet-type pulverizer, followed by classification to obtain the emulsifying agent, and then dispersing it in water in the presence of a suitable dispersant;
(5) a method of obtaining the emulsifying agent by spraying a resin solution, prepared by dissolving a resin previously synthesized via any polymerization reaction, into mist form, and then dispersing it in water in the presence of a suitable dispersant;
(6) a method of precipitating the emulsifying agent by adding a poor solvent to a resin solution prepared by dissolving a previously synthesized resin in a solvent, or by cooling a solution of the emulsifying agent previously dissolved in a heated solvent, followed by removal of the solvent and dispersion in water in the presence of a suitable dispersant;
(7) a method of dispersing a resin solution, prepared by dissolving a previously synthesized resin in a solvent, into a water-based medium in the presence of a suitable dispersant, followed by removal of the solvent by heating or reduced pressure; and
(8) a method of dissolving a suitable emulsifying agent in a resin solution prepared by dissolving a previously synthesized resin in a solvent, followed by phase inversion emulsification by adding water.

### Preparation of Resin Dispersion

In the resin dispersion preparation, a resin dispersion containing an organic solvent, water, resin, and a surfactant is prepared.

Examples of methods of preparing the resin dispersion include, but are not limited to, known techniques such as suspension polymerization, emulsion aggregation, and emulsion dispersion. Among these, the following method is particularly preferred.

First, a material for the resin particles, containing a compound having an active hydrogen group and a polymer capable of reacting with the active hydrogen group, is dissolved in an organic solvent to prepare an oil phase containing the resin. Next, the oil phase is dispersed into an aqueous medium containing a surfactant, and within this aqueous medium, the compound having an active hydrogen group and the polymer capable of reacting with it are reacted to generate particulate adhesive base material, thereby forming the resin dispersion.

In the process of producing resin fine particles, the particles are granulated either in the resin dispersion preparation process or in a distillation process describer below. The mass ratio of resin to surfactant in the resin dispersion determines the particle size and the distribution of the constituent materials within the granulated resin particles. If the surfactant content is too low, the particle size distribution of the resin particles deteriorates.

On the other hand, if the surfactant content is excessively high, the concentration of surfactant on the surface of the resin particles increases, which may lead to deterioration of surface properties, adhesion to the inner wall of the reaction vessel, and reduced recovery rate of the resin particles, resulting in a decrease in overall yield.

There is no specific limitation on the organic solvent as long as it can dissolve or disperse the resin can be suitably selected to a particular application. For example, in terms of easy removal, it is suitable to select a volatile organic solvent having a boiling point of lower than 150 degrees Celsius.

Specific examples of such solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. Among these, toluene, xylene, benzene, methylene chloride, 1,2-dichloroethane, chloroform, and carbon tetrachloride are preferable. In particular, ethyl acetate is especially preferable due to its low boiling point, which facilitates distillation from liquid mixtures, and its reduced tendency to form azeotropes with other materials. These can be used alone or in combination. There is no particular limitation on the amount of the above-mentioned organic solvent to be used, and it may be appropriately selected depending on the purpose. For example, based on 100 parts by mass of the resin particles, 40 to 300 parts by mass is preferable, 60 to 140 parts by mass is more preferable, and 80 to 120 parts by mass is even more preferable. The concentration of the organic solvent is measurable, for example, using a gas chromatography-mass spectrometer (GC-MS).

The above-mentioned aqueous medium contains at least water and may furthermore optionally contain a solvent that is miscible with water.

Specific examples of such water-mixable solvents include, but are not limited to, alcohols, dimethylformamide, tetrahydrofuran, cellosolves, and lower ketones.

Specific examples of the alcohols include, but are not limited to, methanol, isopropanol, and ethylene glycol.

Specific examples of the lower ketones include, but are not limited to, acetone and methyl ethyl ketone. These can be used alone or in combination.

For example, anionic surfactants, cationic surfactants nonionic surfactants, and amphoteric surfactants can be preferably used.

Specific examples of the above-mentioned anionic surfactants include, but are not limited to, alkylbenzene sulfonates (such as sodium dodecyldiphenyl ether disulfonate), α-olefin sulfonates, and phosphate esters. Among these, those having a fluoroalkyl group are preferably used.

Specific examples of the anionic surfactants having a fluoroalkyl group include, but are not limited to, fluoroalkyl carboxylic acids having 2 to 10 carbon atoms and their metal salts, disodium perfluorooctane sulfonylglutamate, sodium 3-{omega-fluoroalkyl (having 6 to 11 carbon atoms) oxy}-1-alkyl (having 3 to 4 carbon atoms) sulfonate, sodium 3-{omega-fluoroalkanoyl (having 6 to 8 carbon atoms)-N-ethylamino}-1-propanesulfonate, fluoroalkyl (having 11 to 20 carbon atoms) carboxylic acids and their metal salts, perfluoroalkylcarboxylic acids (having 7 to 13 carbon atoms) and their metal salts, perfluoroalkyl (having 4 to 12 carbon atoms) sulfonate and their metal salts, perfluorooctanesulfonic acid diethanol amides, N-propyl-N-(2-hydroxyethyl)perfluorooctanesulfone amide, perfluoroalkyl (having 6 to 10 carbon atoms)sulfoneamidepropyltrimethylammonium salts, salts of perfluoroalkyl (having 6 to 10 carbon atoms)-N-ethylsulfonyl glycin, and monoperfluoroalkyl (having 6 to 16 carbon atoms)ethylphosphates.

Specific examples of the procurable products of such surfactants having a fluoroalkyl group include, but are not limited to, SURFLON S-111, S-112 and S-113, which are manufactured by Asahi Glass Co., Ltd.; FRORARD FC-93, FC-95, FC-98 and FC-129, which are manufactured by Sumitomo 3M Limited; UNIDYNE DS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOP EF-102, 103, 104, 105, 112, 123A, 306A, 501, 201 and 204, which are manufactured by Tohchem Products Co., Ltd.; and FUTARGENT F-100 and F150 manufactured by Neos Company limited.

Specific examples of the cationic surfactants include, but are not limited to, amine salt type surfactants and quaternary ammonium salt type anionic surfactants.

Specific examples of the amine salt type surfactants include, but are not limited to, alkyl amine salts, amino alcohol fatty acid derivatives, polyamine fatty acid derivatives, and imidazoline.

Specific examples of the quaternary ammonium salt type cationic surfactants include alkyl trimethyl ammonium salts, dialkyl dimethyl ammonium salts, alkyl dimethyl benzyl ammonium salts, pyridinium salts, alkyl isoquinolinium salts, and benzetonium chloride. Among these, primary, secondary and tertiary aliphatic amines having a fluoroalkyl group, aliphatic quaternary ammonium salts such as perfluoroalkyl (having 6 to 10 carbon atoms) sulfoneamide propyltrimethy lammonium salts, benzalkonium salts, benzetonium chloride, pyridinium salts and imidazolinium salts.

Specific examples of the marketed products of the cationic surfactants include, but are not limited to, SURFLON S-121 (manufactured by Asahi Glass Co., Ltd.), FRORARD FC-135 (manufactured by Sumitomo 3M Limited), UNIDYNE DS-202 (manufactured by Daikin Industries, Ltd.), MEGAFACE F-150 and F-824 (manufactured by Dainippon Ink and Chemicals, Inc.), ECTOP EF-132 (manufactured by Tohchem Products Co., Ltd.), and FUTARGENT F-300 (manufactured by Neos Company Limited).

Specific examples of the nonionic surfactants include, but are not limited to, fatty acid amide derivatives, and polyalcohol derivatives.

Specific examples of amopholytic surfactants include, but are not limited to, alanine, dodecyldi(amino ethyl)glycine, di(octyl amonoethyl)glycine, and N-alkyl-N,N-dimethyl ammonium betaine.

These can be used alone or in combination. Among these, sodium dodecyldiphenyl ether disulfonate is preferable due to its excellent granulation properties for resin fine particles derived from the resin and other materials, and its ease of dispersion into the resin dispersion. The content of the surfactant is measurable, for example, using a liquid chromatography-mass spectrometer (LC-MS).

The resin to surfactant mass ratio is preferably from 1:1 to 1:2, more preferably from 1:1.3 to 1:1.7. If the mass ratio of surfactant is below 1, poor granulation of resin fine particles and inclusion of resin fine particles with degraded surface properties may occur, resulting in adhesion of the resin fine particles to the wall of the reaction vessel and a decrease in recovery yield. If the mass amount of surfactant exceeds 2, the surfactant has the potential to cover the surface of the resin fine particles, making granulation impossible and forming agglomerates with particle sizes exceeding 30 μm, making discharging from the reaction vessel impossible.

The resin dispersion is preferably prepared by dispersing the resin in the aqueous medium during stirring. There is no particular limitation on the dispersion method, and any known stirrer or dispersion device may be suitably selected.

Examples of such stirrers include, but are not limited to, a freestanding type with a movable stirring tank, a suspended type with a fixed stirring tank, and a tank mixer type in which the stirring tank and drive unit are integrated. Among these, a suspended type stirrer with a fixed tank and heat transfer promotion type are preferable, as they can control the particle size of the resin fine particles (oil droplets) to be 10 to 30 μm and maintain a constant heat transfer area on the wall surface of the reaction vessel.

For the heat transfer-promotion stirrer, there is no particular limitation on conditions such as rotation speed, stirring time, and stirring temperature, and they may be suitably selected according to a particular application. For example, the rotation speed is preferably from 0.1 to 1,000 rpm, and more preferably from 1 to 500 rpm. In the case of batch processing, the stirring time is preferably from 0.1 to 1,440 minutes (24 hours). The stirring temperature is preferably from 0 to 150 degrees Celsius under pressure, and more preferably from 40 to 98 degrees Celsius.

Specific examples of the dispersion device include, but are not limited to, a low speed shearing type dispersion device, a high speed shearing type dispersion device, a friction type dispersion device, a high pressure jet type dispersion device, and an ultrasonic dispersion device. Among these, a high-shear dispersion device is preferable due to its ability to control the particle size of the resin fine particles (oil droplets) to 10 to 30 μm. In the case of a high-shear dispersion device, there is no particular limitation on conditions such as rotation speed, dispersion time, and dispersion temperature, and these are suitably selected according to a particular application. For example, the rotation speed is preferably from 1,000 to 30,000 rpm, and more preferably from 5,000 rpm to 20,000 rpm. In the case of batch processing, the dispersion time is preferably from 0.1 minutes to 5 minutes. The dispersion temperature is preferably from 0 to 150 degrees Celsius under pressure, more preferably from 40 to 98 degrees Celsius. It should be noted that, in general, higher stirring and dispersion temperatures tend to facilitate dispersion.

As one example of the method of producing the above-mentioned resin fine particles, a method in which the adhesive base material is granulated to form resin fine particles is described below. In the method of granulating resin fine particles by forming the adhesive base material into particulate form, for example, the following processes are carried out: preparation of an aqueous phase medium, preparation of the oil phase, preparation of the resin dispersion, addition of the aqueous medium, and other processes such as synthesis of a polymer (prepolymer) capable of reacting with the active hydrogen-containing compound, and synthesis of the active hydrogen-containing compound.

Preparation of the above-mentioned aqueous medium phase can be carried out, for example, by dispersing the resin in the aqueous medium. The amount of the resin added to the aqueous medium may be suitably selected according to a particular application. Preparation of the liquid mixture can be carried out by dissolving or dispersing materials such as the active hydrogen-containing compound, a polymer (prepolymer) capable of reacting with the active hydrogen-containing compound, a colorant, a release agent, a charge control agent, and an unmodified polyester resin in the organic solvent. Among the resin fine particle materials, components other than the polymer (prepolymer) capable of reacting with the active hydrogen-containing compound may be added and mixed into the aqueous medium during the preparation of the aqueous medium phase during dispersion of the resin fine particles in the aqueous medium, or alternatively, may be added to the aqueous medium phase together with the liquid mixture containing the resin fine particles.

The preparation of the aforementioned resin dispersion can be carried out by emulsifying or dispersing the previously prepared oil phase into the previously prepared aqueous medium phase. The adhesive base material is produced during emulsification or dispersion when the compound having an active hydrogen group and a polymer reactive with the compound are subjected to an extension reaction or a crosslinking reaction.

The adhesive base material (for example, the urea-modified polyester resin) may be produced by:
(1) emulsifying or dispersing an oil phase containing a polymer capable of reacting with the compound containing an active hydrogen group (e.g., the isocyanate group-containing polyester prepolymer (A)) together with the compound containing an active hydrogen group (e.g., the amines (B)) into the aqueous medium phase to form a dispersion, and allowing both to undergo a chain extension or crosslinking reaction within the aqueous medium phase;
(2) emulsifying or dispersing the oil phase into the aqueous medium phase that has been pre-added with the compound containing an active hydrogen group to form a dispersion, and allowing both to undergo a chain extension or crosslinking reaction within the aqueous medium phase; or
(3) admixing the liquid mixture into the aqueous medium, followed by the addition of the compound containing an active hydrogen group to form a dispersion, and allowing both to undergo a chain extension or crosslinking reaction from the particle interface within the aqueous medium phase. In the case (3), modified polyester resin is preferentially formed on the surface of the resulting resin particles, resulting in a concentration gradient within the resin particles.

As for the reaction conditions for producing the adhesive base material through emulsification or dispersion, there are no particular limitations, and they may be appropriately selected depending on the combination of the polymer capable of reacting with the compound containing an active hydrogen group and the compound itself.

Preferable reaction time ranges from 10 minutes to 40 hours, more preferably from 2 hours to 24 hours. Preferable reaction temperatures range from 0 to 150 degrees Celsius, more preferably from 40 to 98 degrees Celsius.

One method of stably forming the dispersion, in an aqueous medium, containing a polymer (e.g., an isocyanate group-containing polyester prepolymer (A)) that is reactive with the compound having an active hydrogen group involves preparing a liquid mixture by dissolving or dispersing the reactive polymer (e.g., the isocyanate group-containing polyester prepolymer (A)), a colorant, a release agent, a charge control agent, and resin fine particles such as unmodified polyester resin in an organic solvent, and then adding this mixture to the aqueous medium, followed by dispersion with a shear force. Details of the dispersion method are as described above.

The surfactant concentration on the surface of the resin fine particles is measurable using the following method.

Measurement of Surfactant Concentration on Surface of Resin Fine Particle Surface

A dispersion is prepared by adding 0.1 g of resin fine particles to 10 mL of methanol, followed by ultrasonic irradiation for 30 minutes.

The dispersion obtained after ultrasonic irradiation is filtered through a filter with a pore size of μm to obtain a surfactant extract. The obtained surfactant extract is used as the measurement sample. The measurement sample is analyzed under the following analytical conditions using the surfactant as the standard substance and applying the absolute calibration curve method. The surfactant concentration is determined from the maximum peak detected in the measurement sample.

### Analytical Condition

Instrument: LCMS-8030 (manufactured by Shimadzu Corporation)·
Column: InertSustain® Swift C18 (particle size: 2 μm, inner diameter: 2.1 mm, length: 100 mm; manufactured by GL Sciences Inc.)
Mobile Phase:
Solution A: 0.5 percent by volume ammonium acetate aqueous solution/methanol=80 percent/20 percent (v/v)
Solution B: Methanol
Gradient Program: The mobile phase composition changed from A/B=0 percent/100 percent (v/v) to A/B=100 percent/0 percent (v/v) over 10 minutes, followed by a 5 minute hold.

It is then changed back to A/B=0 percent/100 percent (v/v) over 15 minutes, followed by another 5 minute hold.
Flow Rate: 0.3 mL/min
Injection Volume: 0.2 μL

The surfactant concentration on the surface of the resin fine particles, determined by the above-described method, is preferably in the range of 500 to 1,000 ppm, and more preferably in the range of 700 to 800 ppm. If the concentration is below 500 ppm, contact between resin fine particles tends to cause aggregation, making it difficult to granulate to a desired particle size. On the other hand, if the concentration exceeds 1,000 ppm, the excessive presence of surfactant tends to cause a decline in the functionality of the resin fine particles due to the hygroscopic nature of the surfactant, and is therefore undesirable.

In the preparation of the resin dispersion, dispersants other than surfactants may be optionally used. There is no specific limitation on the dispersant and any known dispersion agent can be suitably used.

Examples include, but are not limited to, surfactants, inorganic compound dispersants sparingly soluble in water, and polymeric protective colloids. These can be used alone or in combination.

Inorganic compounds such as tricalcium phosphate, calcium phosphate, titanium oxide, colloidal silica, and hydroxyapatite are also suitable as inorganic dispersants that are sparingly soluble in water.

Specific examples of the polymeric protective colloids include, but are not limited to, acids, (meth)acrylic monomer having a hydroxyl group, vinyl alcohol or ethers thereof, esters of vinyl alcohol and a compound having a carboxylic group, amide compounds or methylol compounds thereof, chlorides, homopolymers or copolymers having a nitrogen atom or a heterocyclic ring thereof, polyoxyethylene based compounds and celluloses.

Specific examples of the acids include, but are not limited to, acrylic acid, methacrylic acid, α-cyanoacrylic acid, α-cyanomethacrylic acid, itaconic acid, crotonic acid, fumaric acid, maleic acid and maleic anhydride. Specific examples of (meth)acrylic monomers having a hydroxyl group include, but are not limited to, β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycolmonoacrylate, diethylene glycolmonomethacrylate, glycerinmonoacrylate, glycerinmonomethacrylate, N-methylol acryl amide, and N-methylol methacryl amide. Specific examples of vinyl alcohols mentioned above or its ethers include vinyl methyl ether, vinyl ethyl ether, and vinyl propyl ether.

Specific examples of the esters mentioned above of vinyl alcohol and a compound having a carboxylic group include, but are not limited to, vinyl acetate, vinyl propionate and vinyl butyrate.

Specific examples of the amide compounds mentioned above or their methylol compounds include, but are not limited to, acrylamide, methacrylamide and diacetone acrylamide acid and their methylol compounds.

Specific examples of the chlorides mentioned above include, but are not limited to, acrylic acid chloride and methacrylic acid chloride.

Specific examples of homopolymers or copolymers mentioned above having a nitrogen atom or a heterocyclic ring thereof include, but are not limited to, vinyl pyridine, vinyl pyrrolidone, vinyl imidazole and ethylene imine.

Specific examples of the polyoxyethylene mentioned above include, but are not limited to, polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters.

Specific examples of the celluloses mentioned above include, but are not limited to, methyl cellulose, hydroxyethyl cellulose and hydroxypropyl cellulose.

A dispersion stabilizer can be optionally used in preparation of the resin dispersion mentioned above.

Specific examples of the dispersion stabilizers include, but are not limited to, compounds such as calcium phosphate which are soluble in an alkali or an acid. If such a dispersion stabilizer is used, calcium phosphate can be removed from particulates by a method of washing with water or a method of decomposing with enzyme after dissolving calcium phosphate with an acid such as hydrochloric acid.

In the resin dispersion mentioned above is prepared, a catalyst for extension and/or cross-linking reaction can be used.

Specific examples thereof include, but are not limited to, dibutyltin laurate and dioctyltin laurate.

### Distillation Process

In the distillation process, the organic solvent is removed from the resin dispersion by distillation.

It is preferable that the removal of the organic solvent be carried out under at least one of reduced pressure and heated conditions. This removal increases the evaporation rate of the organic solvent, thereby improving productivity. Additionally, controlling the degree of vacuum enables adjustment of the particle size of the resin fine particles. In certain cases, the resin has some solubility in the organic solvent; therefore, rapid removal of the organic solvent under reduced pressure inhibits fusion between resin particles and prevents deterioration of surface quality of the resin fine particles. The heating is preferably performed either by passing hot air or steam, generated by a heat pump, through a jacket provided around the distilling tank, or by heating a storage tank containing the organic solvent using a heater. Among these, hot air generated by a heat pump is particularly preferable due to its temperature stability and the potential for reducing CO₂ emissions.

Any known apparatus may be used as the container for removing the organic solvent from the resin dispersion, provided it is equipped with a stirrer and a heating device (such as a jacket or heater) for heating the container wall. From the standpoint of facilitating solvent removal, preferable configurations include those equipped with a heat pump connected to the heating device, those with vacuum facilities, and those capable of introducing compressed air or nitrogen gas.

In the removed organic solvent, the surfactant concentration in the organic solvent is preferably in the range of 0.1 to 300 ppm, and more preferably in the range of 0.1 to 10 ppm. If the concentration is below 0.1 ppm, purification of components other than the organic solvent results in multiple processes in some cases, which is undesirable in terms of solvent recovery efficiency and cost. If the concentration exceeds 300 ppm, the hygroscopic nature of the surfactant may adversely affect the functionality of the organic solvent, and is therefore not preferable.

The surfactant concentration in the organic solvent is measurable using the following method:

### Measurement of Surfactant Concentration in Organic Solvent

A dispersion is prepared by adding 0.5 g of the organic solvent to 10 mL of methanol, followed by ultrasonic irradiation for 30 minutes to prepare a measurement sample. The measurement sample is analyzed under the following analytical conditions using the surfactant as the standard substance and applying the absolute calibration curve method. The surfactant concentration in the organic solvent is determined based on the maximum peak detected in the measurement sample.

### Analytical Condition

Instrument: LCMS-8030 (manufactured by Shimadzu Corporation)
Column: InertSustain® Swift C18 (particle size: 2 μm, inner diameter: 2.1 μm, length: 100 μm; manufactured by GL Sciences Inc.)·
Mobile Phase:
Solution A: 0.5 percent by volume ammonium acetate aqueous solution/methanol=80 percent/20 percent (v/v)
Solution B: Methanol
Gradient Program: The mobile phase composition changed from A/B=0 percent/100 percent (v/v) to A/B=100 percent/0 percent (v/v) over 10 minutes, followed by a 5 minute hold.

It was then changed back to A/B=0 percent/100 percent (v/v) over 15 minutes, followed by another 5 minute hold.
Flow Rate: 0.3 mL/min
Injection Volume: 0.2 μL

After the removal of the organic solvent, resin fine particles are obtained. The resin fine particles are optionally subjected to washing, drying, and classification or other treatments. This classification may be carried out, for example, by removing fine particles in a liquid medium using a cyclone, decanter, or centrifugal separator. Alternatively, powder obtained after drying can be subjected to classification.

When the resin fine particles thus obtained are mixed with particles such as a colorant, release agent, and charge control agent, and then subjected to mechanical impact, the particles—such as the release agent—are prevented from detaching from the surface of the resin fine particles.

Specific examples of the method of applying such a mechanical impact include, but are not limited to, methods in which an impact is applied to a mixture by using a blade rotating at a high speed, a method in which a mixture is put into a jet air to cause particles to collide with each other or complicated particles to collide against a suitable collision board.

Specific examples of such devices that apply a mechanical impact include, but are not limited to, ONG MILL (available from Hosokawa Micron Co., Ltd.), modified I TYPE MILL (available from Nippon Pneumatic Mfg. Co., Ltd.) in which the pressure of pulverization air is reduced, HYBRIDIZATION SYSTEM (manufactured by Nara Machine Co., Ltd.), KRYPTRON SYSTEM (available from Kawasaki Heavy Industries, Ltd.), and automatic mortars.

The obtained resin fine particles preferably have properties such as a volume average particle diameter (Dv), a ratio of volume average particle diameter (Dv) to number average particle diameter (Dn), and an average circularity.

The particle diameter of the resin fine particles is a characteristic value that defines granulation properties. The volume average particle diameter and the ratio of the volume average particle diameter to the number average particle diameter (Dv/Dn) are measurable, for example, using a particle size analyzer such as the Multisizer 4e (manufactured by Beckman Coulter). Specifically, 0.1 to 5 mL of an alkylbenzene sulfonate surfactant is added to 100 to 150 mL of ISOTON-II electrolyte solution (manufactured by Beckman Coulter), followed by addition of 2 to 20 mg of the resin fine particles. The mixture is then dispersed for about 1 to 3 minutes using an ultrasonic disperser. Subsequently, the volume average particle diameter of the toner is measured using the Multisizer 4e precision particle size analyzer (manufactured by Beckman Coulter) with a 100 μm aperture. The whole range is a particle diameter of from 2.00 μm to not greater than 40.30 μm and the number of the channels is 13.

Channels are: from 2.00 μm to not greater than 2.52 μm; from 2.52 μm to not greater than 3.17 μm; from 3.17 μm to not greater than 4.00 μm; from 4.00 μm to not greater than 5.04 μm; from 5.04 μm to not greater than 6.35 μm; from 6.35 μm to not greater than 8.00 μm; from 8.00 μm to not greater than 10.08 μm; from 10.08 μm to not greater than 12.70 μm; from 12.70 μm to not greater than 16.00 μm, from 16.00 μm to not greater than 20.20 μm; from 20.20 μm to not greater than 25.40 μm; from 25.40 μm to not greater than 32.00 μm; and from 32.00 μm to not greater than 40.30 μm.

The volume average particle diameter (Dv) of the resin fine particles is preferably, for example, 10 to 30 μm, more preferably 15 to 25 μm, and still more preferably 17 to 23 μm. When the volume average particle diameter is less than 10 μm, the yield tends to decrease due to reduction in recovery rate during the collection of the resin fine particles. On the other hand, when the volume average particle diameter exceeds 30 μm, the yield may decrease due to adhesion of the particles to the inner wall of the container.

The ratio (Dv/Dn) of the volume average particle diameter (Dv) to the number average particle diameter (Dn) of the resin fine particles is preferably at most 1.25, more preferably 1.00 to 1.20, and still more preferably 1.10 to 1.20. If the Dv/Dn ratio is at most 1.25, the particle size distribution of the resin fine particles tends to be relatively sharp, which improves the yield.

If the Dv/Dn ratio is less than 1.00, the resin fine particles tend to fuse to the inner wall of the container during prolonged stirring, potentially reducing the yield. If the Dv/Dn ratio exceeds 1.20, it is likely to become difficult to obtain high-resolution and high-quality images when the particles are used as toner.

The average circularity is a value obtained by dividing the circumference of a circle corresponding to the projection area of the resin fine particle shape by the circumference of the real particle and is preferably, for example, 0.94 to 0.99 and more preferably 0.95 to 0.98. It is preferable that particles having an average circularity of less than 0.94 account for at most 15 percent. If the average circularity is less than 0.94, the resin fine particles tend to fuse to the inner wall of the container during prolonged stirring, which may lead to a decrease in yield. The average circularity is measurable, for example, by an optical detection method in which a suspension containing the resin fine particles is passed through an imaging detection zone on a flat plate, and particle images are optically detected and analyzed using a CCD camera. Specifically, the measurement can be performed using, for example, a flow-type particle image analyzer such as the FPIA-2100 (manufactured by Sysmex Corporation).

### Distillation Device

The distillation device of the present disclosure will be described with reference to the drawing. The drawing is a schematic diagram illustrating an example of the distilling device. A distillation device 1 includes a distilling tank 10, a stirrer 11, a heating device 20, a heat pump 21, a heating control unit 22, a condenser 31, a collection container 32, a vacuum pump 33, and a pressure control unit 34, among others. The distillation device 1 removes an organic solvent from a resin dispersion containing the organic solvent, water, a resin, and a surfactant by distillation.

The distilling tank 10 is a container that holds the resin dispersion and performs the distillation. The heating device 20 in a jacket form is provided around the outer periphery of the distilling tank 10 to heat the wall of the vessel, thereby enabling heating of the resin dispersion contained therein. The distilling tank 10 is connected to the vacuum pump 33 via piping and the condenser 31, and the vacuum pump 33 is operated to depressurize the interior of the distilling tank 10. Distillation may be performed by either heating with the heating device 20 or depressurization with the vacuum pump 33, or by both.

The stirrer 11 stirs the resin dispersion contained in the distilling tank 10 by rotating stirring blades 11a fixed to the tip of a stirring shaft. In the drawing, paddle blades are illustrated as an example of the stirring blades 11a, but the shape of the stirring blades is not particularly limited and is appropriately selected depending on the viscosity of the resin dispersion. Examples include, but are not limited to, turbine blades, propeller blades, ribbon blades, and anchor blades.

The heating device 20 is connected to the heat pump 21 and heats the wall of the distilling tank 10 by passing hot air through the jacket. Heating with hot air generated by the heat pump 21 provides the advantage of stabilizing the temperature inside the distilling tank 10 and reducing CO₂ emissions.

The heat pump 21 is connected to the heating control unit 22 and is controlled based on signals from the heating control unit 22. The heating control unit 22 monitors the temperature inside the distilling tank 10 and controls the operation of the heat pump 21 to change the internal temperature of the distilling tank 10 stepwise.

By operating the vacuum pump 33 to depressurize the interior of the distilling tank 10, volatile components contained in the resin dispersion are vaporized and reach the condenser 31 through the piping. The condenser 31 is equipped with a cooling mechanism, and the vaporized volatile components are condensed by cooling and collected in the collection container 32 provided below.

The vacuum pump 33 is connected to the pressure control unit 34 and is controlled based on signals from the pressure control unit 34. The pressure control unit 34 monitors the pressure inside the distilling tank 10 and controls the operation of the vacuum pump 33 to change the internal pressure of the distilling tank 10 stepwise.

Since the distillation device 1 enables changes in the temperature and pressure inside the distilling tank 10 stepwise, it is possible to perform distillation quickly while avoiding bumping.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight rations in parts, unless otherwise specified.

### EXAMPLES

The present disclosure is described next in detail with reference to specific Examples but is not limited to these Examples.

### Synthesis of Polyester Resin A1

In a reaction vessel equipped with a cooling tube, a stirrer, and a nitrogen inlet tube, 690 parts by mass of an adduct of bisphenol A with 2 mols of ethylene oxide and 335 parts by mass of terephthalic acid were charged, and a condensation reaction was carried out at 210 degrees Celsius for 10 hours under a nitrogen stream at atmospheric pressure. Subsequently, the reaction was continued for 5 hours under reduced pressure of 10 to 15 mmHg during dehydration, followed by cooling to obtain Polyester Resin A1. The obtained Polyester Resin A1 had a weight average molecular weight of 6,000, an acid value of 10 mgKOH/g, and a glass transition temperature of 48 degrees Celsius.

### Synthesis of Styrene Acrylic Resin A2

Under a nitrogen stream at atmospheric pressure, 160 parts by mass of N,N-dimethylformamide were charged into a reaction vessel equipped with a cooling tube, a stirrer, and a nitrogen introducing tube, and the liquid temperature was raised to 90 degrees Celsius. While the liquid temperature at 90 degrees Celsius was maintained, 190 parts by mass of styrene monomer were added, followed by the addition of 10 parts by mass of acrylonitrile. Separately, 0.8 g of azobisisobutyronitrile and 40 g of N,N-dimethylformamide were mixed, and the resulting mixture was added dropwise over 10 hours using a dropping funnel.

After this dropwise addition, the mixture was stirred for 2 hours at 90 degrees Celsius to carry out the condensation reaction. Subsequently, the reaction was continued for 2 hours under reduced pressure of 10 to 15 mmHg during dehydration, followed by cooling to obtain Styrene-Acrylic Resin A2. The obtained Styrene-Acrylic Resin A2 had a weight average molecular weight of 5,500.

### Synthesis of Prepolymer B

In a reaction vessel equipped with a cooling tube, a stirrer, and a nitrogen inlet tube, 795 parts by mass of an adduct of bisphenol A with 2 mols of ethylene oxide, which was derived from polyester, 200 parts by mass of isophthalic acid, 65 parts by mass of terephthalic acid, and 2 parts by mass of dibutyltin oxide were charged, and a condensation reaction was carried out at 210 degrees Celsius for 8 hours under a nitrogen stream at atmospheric pressure. Subsequently, the reaction was continued for 5 hours under reduced pressure of 10 to 15 mmHg during dehydration, followed by cooling to 80 degrees Celsius. Then 170 parts by mass of isophorone diisocyanate were added in ethyl acetate, and the mixture was reacted for 2 hours to obtain Prepolymer B. The obtained Prepolymer B had a weight average molecular weight of 5,000.

### Example 1

### Preparation of Oil Phase

Into a reaction vessel, 170 parts by mass of an ethyl acetate dispersion containing 35 percent by mass carnauba wax, 120 parts by mass of Polyester Resin A1, 20 parts by mass of C.I. PY155 (yellow pigment, manufactured by Clariant), 70 parts by mass of ethyl acetate, 2 parts by mass of isophorone diamine, 25 parts by mass of Prepolymer B, and 25 parts by mass of ethyl acetate were charged, followed by stirring for 4 hours to dissolve and mix the components, thereby obtaining Oil Phase 1 containing an organic solvent and resin.

### Preparation of Aqueous Medium Phase

In a separate reaction vessel, 945 parts by mass of water, 40 parts by mass of a 20 mass percent aqueous dispersion of a styrene-methacrylic acid-butyl acrylate copolymer, 435 parts by mass of a 50 mass percent aqueous dispersion of N-alkyl-N,N-dimethylammonium betaine (amphoteric surfactant), and 90 parts by mass of ethyl acetate were charged and mixed with stirring to obtain Aqueous Medium Phase 1. Preparation of Resin Dispersion

Next, Oil Phase 1 was added to Aqueous Medium Phase 1, and the mixture was stirred continuously for 2 hours at a rotation speed of 250 rpm using a fixed-suspension-type heat-transfer-promotion stirrer. Through the process of dispersing resin fine particles in the aqueous medium, Resin Dispersion 1 containing an organic solvent, water, resin, and surfactant was prepared.

### Distillation Process

The obtained Resin Dispersion 1 was charged into the distilling tank of a distillation device having the configuration illustrated in the drawing. The wall of the vessel was heated with hot air generated by a heat pump, and distillation was carried out under gradually reduced pressure at a jacket temperature of 40 degrees Celsius and a stirring speed of 250 rpm, while avoiding bumping, under a reduced pressure condition of −90 kPa. The concentration of the organic solvent before the start of distillation was used as the starting point. The organic solvent concentration was determined by measuring the residual organic solvent concentration in Resin Dispersion 1 at regular intervals using gas chromatography (GC-2010, manufactured by Shimadzu Corporation). The organic solvent concentration at the starting point was 18.8 percent by mass. Distillation was continuously carried out for 2 hours until the organic solvent concentration in Resin Dispersion 1 became less than 0.1 percent by mass, thereby removing the organic solvent from Resin Dispersion 1.

### Recovery of Resin Fine Particles

Subsequently, Resin Dispersion 1, from which the organic solvent had been removed, was filtered, washed, and dried. Then using an air classification system (Elbow Jet Classifier EJ-150, manufactured by MATSUBO Corporation), the powder obtained was classified into, fine powder (F powder) of less than 10 μm, medium powder (M powder) of 10 to 30 μm, and coarse powder (G powder) of more than 30 μm, and the resin fine particles were recovered.

The resin fine particles obtained were evaluated by calculating the volume average particle diameter, surface surfactant concentration, average value of P₂₈₅₀/P₈₂₈, the proportion of particles having P₂₈₅₀/P₈₂₈ of at least 0.40, and the yield, using the method described above. In addition, the surfactant concentration in the organic solvent recovered during the distillation process was also determined.

### Example 2

Resin fine particles were obtained in the same manner as in Example 1 except that the surfactant was changed from N-alkyl-N,N-dimethylammonium betaine (amphoteric surfactant) to sodium dodecyldiphenyl ether disulfonate (anionic surfactant), and the organic solvent was changed from ethyl acetate to methyl ethyl ketone.

### Example 3

Resin fine particles were obtained in the same manner as in Example 1 except that the surfactant was changed from N-alkyl-N,N-dimethylammonium betaine (amphoteric surfactant) to sodium dodecyldiphenyl ether disulfonate (anionic surfactant), and polyester resin A1 was replaced with styrene acrylic resin A2.

### Example 4

Resin fine particles were obtained in the same manner as in Example 1 except that the surfactant was changed from N-alkyl-N,N-dimethylammonium betaine (amphoteric surfactant) to sodium dodecyldiphenyl ether disulfonate (anionic surfactant), and the distillation process was carried out without heating the wall.

### Example 5

Resin fine particles were obtained in the same manner as in Example 1 except that the surfactant was changed from N-alkyl-N,N-dimethylammonium betaine (amphoteric surfactant) to sodium dodecyldiphenyl ether disulfonate (anionic surfactant), and the distillation process was carried out without depressurizing.

### Example 6

Resin fine particles were obtained in the same manner as in Example 1 except that the surfactant was changed from N-alkyl-N,N-dimethylammonium betaine (amphoteric surfactant) to sodium dodecyldiphenyl ether disulfonate (anionic surfactant), and the distillation process was carried out by heating with vapor instead of hot air.

### Example 7

Resin fine particles were obtained in the same manner as in Example 1 except that the surfactant was changed from N-alkyl-N,N-dimethylammonium betaine (amphoteric surfactant) to sodium dodecyldiphenyl ether disulfonate (anionic surfactant).

### Comparative Example 1

Resin fine particles were obtained in the same manner as in Example 1 except that the surfactant was changed from N-alkyl-N,N-dimethylammonium betaine (amphoteric surfactant) to sodium dodecyldiphenyl ether disulfonate (anionic surfactant), and the amount of the surfactant added was changed from 217.5 parts by mass to 43.5 parts by mass.

### Comparative Example 2

Resin fine particles were obtained in the same manner as in Example 1 except that the surfactant was changed from N-alkyl-N,N-dimethylammonium betaine (amphoteric surfactant) to sodium dodecyldiphenyl ether disulfonate (anionic surfactant), and the amount of the surfactant added was changed from 217.5 parts by mass to 507.5 parts by mass. However, in Comparative Example 2, resin fine particles could not be obtained due to poor granulation.

Table 1 shows the composition of the resin fine particles and the distillation methods in Examples 1 to 7 and Comparative Examples 1 and 2.

In Table 1, EA stands for ethyl acetate, and MEK stands for methyl ethyl ketone.

TABLE 1

| | | Example | Example | Example | Example | Example |
|---|---|---|---|---|---|---|
| | | 1 | 2 | 3 | 4 | 5 |
| Amount | Polyester | 120 | 120 | | 120 | 120 |
| added | resin A1 | | | | | |
| (parts by | Styrene | | | 120 | | |
| mass) | acrylic | | | | | |
| | resin A2 | | | | | |
| | Prepolymer B | 25 | 25 | 25 | 25 | 25 |
| | Amphoteric | 217.5 | | | | |
| | surfactant | | | | | |
| | Anionic | | 217.5 | 217.5 | 217.5 | 217.5 |
| | surfactant | | | | | |

| | | | | | |
|---|---|---|---|---|---|
| Mass ratio between resin | 1:1.5 | 1:1.5 | 1:1.5 | 1:1.5 | 1:1.5 |
| and surfactant | | | | | |
| Organic solvent | EA | MEK | EA | EA | EA |
| Presence or absence of | Yes | Yes | Yes | None | Yes |
| wall heating | | | | | |
| Presence or absence of | Yes | Yes | Yes | Yes | None |
| depressurization | | | | | |
| Heating method | Heat | Heat | Heat | Heat | Heat |
| | pump | pump | pump | pump | pump |

| | | Example | Example | Comparative | Comparative |
|---|---|---|---|---|---|
| | | 6 | 7 | Example 1 | Example 2 |
| Amount | Polyester | 120 | 120 | 120 | 120 |
| added | resin A1 | | | | |
| (parts by | Styrene | | | | |
| mass) | acrylic | | | | |
| | resin A2 | | | | |
| | Prepolymer B | 25 | 25 | 25 | 25 |
| | Amphoteric | | | | |
| | surfactant | | | | |
| | Anionic | 217.5 | 217.5 | 43.5 | 507.5 |
| | surfactant | | | | |

| | | | | |
|---|---|---|---|---|
| Mass ratio between resin | 1:1.5 | 1:1.5 | 1:0.3 | 1:3.5 |
| and surfactant | | | | |
| Organic solvent | EA | EA | EA | EA |
| Presence or absence of | Yes | Yes | Yes | Yes |
| wall heating | | | | |
| Presence or absence of | Yes | Yes | Yes | Yes |
| depressurization | | | | |
| Heating method | Vapor | Heat | Heat | Heat |
| | heating | pump | pump | pump |

### The Methods of Producing Resin Fine Particles in Examples and Comparative

Examples were evaluated based on the following items. The evaluation results are shown in Table 2.

### Granularity

The volume average particle diameter of the resin fine particles obtained was evaluated according to the following evaluation criterion. A rating of B or higher was considered as passing.

### Evaluation Criteria

S: 17 to 23 μm
A: 15 to less than 17 μm or greater than 23 to 25 μm
B: 10 to less than 15 μm or greater than 25 to 30 μm
C: less than 10 μm or greater than 30 μm (including cases where measurement was not possible)

### Recyclability of Organic Solvent

The concentration of surfactant in the organic solvent recovered during the distillation process was evaluated based on the following criterion. A rating of B or higher was considered as passing.

### Evaluation Criteria

S: at most 10 ppm
A: greater than 10 ppm to 100 ppm
B: greater than 100 ppm to 300 ppm
C: greater than 300 ppm

### Fixation on Inner Wall Surface

After completion of the distillation process, the inner wall surface of the distilling tank was visually inspected and evaluated based on the following criterion. A rating of B or higher was considered as passing.

### Evaluation Criteria

S: The inner wall surface of the distilling tank was nearly free of residual deposits.
A: A small amount of residual deposits was present on the inner wall surface of the distilling tank
B: The wall surface was covered with a layer of residual deposits
C: Irregularly shaped residual deposits were present on the inner wall surface of the distilling tank

### Yield

The yield of the resin fine particles obtained was evaluated according to the following evaluation criterion. A rating of B or higher was considered as passing.

### Evaluation Criteria

S: at least 98 percent
A: 90 to less than 98 percent
B: 75 to less than 90 percent
C: less than 75 percent

TABLE 2

| | | Example | Example | Example | Example | Example |
|---|---|---|---|---|---|---|
| | | 1 | 2 | 3 | 4 | 5 |
| Volume average particle | | 29 | 11 | 14 | 27 | 24 |
| diameter (μm) of resin fine | | | | | | |
| particle | | | | | | |
| Concentration of surfactant | | 280 | 210 | 120 | 105 | 60 |
| in organic solvent | | | | | | |
| Yield (percent) | | 75 | 78 | 80 | 85 | 92 |
| Evaluation | Granularity | B | B | B | B | A |
| | Recyclability | B | B | B | B | A |
| | of organic | | | | | |
| | solvent | | | | | |
| | Residual | B | B | B | B | A |
| | deposits on | | | | | |
| | inner wall | | | | | |
| | surface | | | | | |
| | Yield | B | B | B | A | A |

| | | Example | Example | Comparative | Comparative |
|---|---|---|---|---|---|
| | | 6 | 7 | Example 1 | Example 2 |
| Volume average particle | | 15 | 20 | 3 | Unmeasurable |
| diameter (μm) of resin fine | | | | | |
| particle | | | | | |
| Concentration of surfactant | | 9 | 5 | 600 | 450 |
| in organic solvent | | | | | |
| Yield (percent) | | 97 | 99 | 30 | 50 |
| Evaluation | Granularity | A | S | C | C |
| | Recyclability | S | S | C | C |
| | of organic | | | | |
| | solvent | | | | |
| | Residual | S | S | C | C |
| | deposits on | | | | |
| | inner wall | | | | |
| | surface | | | | |
| | Yield | A | S | C | C |

As seen in the results shown in Table 2, these results demonstrate that the method of manufacturing resin fine particles in Examples 1 to 7, with a resin-to-surfactant mass ratio of 1:1 to 1:2, suppressed the adhesion of resin fine particles to the container wall surface. In addition, the manufacturing method in Examples 1 to 7 has an advantage of high recyclability of the organic solvent recovered by distillation, resulting in lower environmental impact.

On the other hand, the manufacturing methods in Comparative Examples 1 and 2, in which the mass ratio of resin to surfactant is outside the range of 1:1 to 1:2, result in poor granulation or inclusion of resin fine particles with degraded surface properties, leading to adhesion of resin fine particles to the container wall surface as a problem.

Next, the resin fine particles obtained in Examples and Comparative Examples were evaluated for their suitability as resin fine particles based on the following items. The evaluation results are shown in Table 3. It should be noted that the applications of the resin fine particles are not particularly limited, and the present disclosure is not restricted to the examples described below.

### Granularity

The volume average particle diameter of the resin fine particles obtained was evaluated according to the following evaluation criterion. A rating of B or higher was considered as passing.

### Evaluation Criterion

S: 17 to 23 μm
A: 15 to less than 17 μm or greater than 23 to 25 μm
B: 10 to less than 15 μm or greater than 25 to 30 μm
C: less than 10 μm or greater than 30 μm (including cases where measurement was not possible)

### Surfactant Concentration on Resin Fine Particle Surface

The surfactant concentration on the resin fire particles obtained was evaluated according to the following evaluation criterion. A rating of B or higher was considered as passing.

### Evaluation Criterion

S: 700 to 800 ppm
A: 600 to less than 700 ppm, or greater than 800 to 900 ppm
B: 500 to less than 600 ppm or greater than 900 to 1000 ppm
C: less than 500 ppm or greater than 1000 ppm

### Amount (Average) of Release Agent on Surface

Based on the analysis of the obtained resin fine particles using the FTIR-ATR (Attenuated Total Reflectance Fourier Transform Infrared Spectroscopy) method, the average intensity ratio (P₂₈₅₀/P₈₂₈) was calculated by dividing the absorption spectral peak intensity P₂₈₅₀ at wavenumber 2850 cm⁻¹ by the absorption spectral peak intensity P₈₂₈ at wavenumber 828 cm⁻¹. Evaluation was conducted according to the following criterion. The average value of the intensity ratio (P₂₈₅₀/P₈₂₈) was measured at an infrared incident angle of 41.5 degree, with a resolution of 4 cm⁻¹ and 20 accumulations. The intensity ratio (P₂₈₅₀/P₈₂₈) was determined based on the average value obtained from a hundred measurements. A rating of B or higher was considered as passing.

### Evaluation Criterion

S: Average of intensity ratio (P₂₈₅₀/P₈₂₈) is 0.27 to 0.33
A: Average of intensity ratio (P₂₈₅₀/P₈₂₈) is 0.25 to less than 0.27, or greater than 0.33 to 0.35
B: Average of intensity ratio (P₂₈₅₀/P₈₂₈) is 0.20 to less than 0.25, or greater than 0.35 to 0.40
C: Average of intensity ratio (P₂₈₅₀/P₈₂₈) is less than 0.20, or greater than 0.40

### Amount of Release Agent on Surface (Ratio)

Based on the analysis of the obtained resin fine particles from the hundred measurements using the FTIR-ATR (Attenuated Total Reflectance Fourier Transform Infrared Spectroscopy) method, the proportion the intensity ratio (P₂₈₅₀/P₈₂₈) having at least 0.40 was calculated, and evaluation was conducted according to the following criterion. A rating of B or higher was considered as passing.

### Evaluation Criteria

S: the proportion of the intensity ratio (P₂₈₅₀/P₈₂₈) having at least 0.40 was between 27 percent and 33 percent
A: the proportion of the intensity ratio (P₂₈₅₀/P₈₂₈) having at least 0.40 was 20 to less than 27 percent, or greater than 33 to 40 percent
B: the proportion of the intensity ratio (P₂₈₅₀/P₈₂₈) having at least 0.40 was 10 to less than 20 percent, or greater than 40 percent to 50 percent
C: the proportion of the intensity ratio (P₂₈₅₀/P₈₂₈) having at least 0.40 was less than 10 percent, or greater than 50 percent

### Total Evaluation

The resin fine particles were evaluated according to the following criterion from the perspective of versatility for various applications, using the following indicators: granulation performance (i.e., being in fine particle form), and the ability to function as a resin (i.e., less compositional deviation and ease of mixing with other constituent materials). A rating of B or higher was considered as passing.

### Evaluation Criterion

S: suitable for a wide range of applications
A: Limited applicability to certain uses, but generally acceptable
B: Applicability is restricted, but still within an acceptable range
C: Not suitable for the intended applications.

TABLE 3

| | | Example | Example | Example | Example | Example |
|---|---|---|---|---|---|---|
| | | 1 | 2 | 3 | 4 | 5 |
| Volume average particle | | 29 | 11 | 14 | 27 | 24 |
| diameter (μm) | | | | | | |
| Concentration of surfactant | | 990 | 520 | 860 | 650 | 690 |
| on surface | | | | | | |
| Average of P₂₈₅₀/P₈₂₈ | | 0.21 | 0.40 | 0.38 | 0.26 | 0.35 |
| Proportion (percent) of | | 50 | 10 | 45 | 21 | 36 |
| P₂₈₅₀/P₈₂₈ having at least | | | | | | |
| 0.40 | | | | | | |
| Evaluation on | Granularity | B | B | B | B | A |
| applicability | Concentration | B | B | B | B | A |
| | on surfactant | | | | | |
| | Amount of | B | B | B | A | A |
| | release agent | | | | | |
| | (average) | | | | | |
| | Amount of | B | B | B | A | A |
| | release agent | | | | | |
| | (average) | | | | | |

| | | | | | |
|---|---|---|---|---|---|
| Total evaluation | B | B | B | A | A |

| | | Example | Example | Comparative | Comparative |
|---|---|---|---|---|---|
| | | 6 | 7 | Example 1 | Example 2 |
| Volume average particle | | 15 | 20 | 3 | Unmeasurable |
| diameter (μm) | | | | | |
| Concentration of surfactant | | 820 | 750 | 100 | 5000 |
| on surface | | | | | |
| Average of P₂₈₅₀/P₈₂₈ | | 0.27 | 0.30 | 0.40 | 0.20 |
| Proportion (percent) of | | 25 | 30 | 80 | 3 |
| P₂₈₅₀/P₈₂₈ having at least | | | | | |
| 0.40 | | | | | |
| Evaluation on | Granularity | A | S | C | C |
| applicability | Concentration | S | S | C | C |
| | on surfactant | | | | |
| | Amount of | S | S | C | C |
| | release agent | | | | |
| | (average) | | | | |
| | Amount of | A | S | C | C |
| | release agent | | | | |
| | (average) | | | | |

| | | | | |
|---|---|---|---|---|
| Total evaluation | A | S | C | C |

As seen in the results shown in Table 3, the resin fine particles obtained in Examples 1 to 7 are found to exceed the acceptance criteria in all evaluation items-volume average particle diameter, surfactant concentration on the surface, and release agent content- and are considered to be highly versatile resin fine particles.

On the other hand, in Comparative Examples 1 and 2, the resin fine particles fell below the acceptance criteria in all items, indicating that they are not highly versatile resin fine particles.

Aspects of the embodiments of the present invention are, for example, as follows:

### Aspect 1

A method of manufacturing resin fine particles includes preparing a resin dispersion containing an organic solvent, water, a resin, and a surfactant, and distilling the resin dispersion to remove the organic solvent, wherein the mass ratio of the resin to the surfactant is from 1:1 to 1:2.

### Aspect 2

The method according to Aspect 1 mentioned above, wherein the resin fine particles have a volume average particle diameter of 10 to 30 μm.

### Aspect 3

The method according to Aspect 1 or 2 mentioned above, wherein the surfactant contains sodium dodecyldiphenyl ether disulfonate.

### Aspect 4

The method according to any one of Aspects 1 to 3, wherein the organic solvent contains ethyl acetate.

### Aspect 5

A resin fine particle composition contains resin fine particles each containing a resin that contains a polyester resin, a colorant, a release agent, and a surfactant, wherein the resin fine particles have a volume-average particle diameter of 10 to 30 μm, the surfactant has a concentration of 500 to 1000 ppm at surfaces of the resin fine particles, the average value of the intensity ratio (P₂₈₅₀/P₈₂₈) of the absorption spectral peak intensity P₂₈₅₀ at a wavenumber of 2850 cm⁻¹ to the absorption spectral peak intensity P₈₂₈ at a wavenumber of 828 cm⁻¹, as determined by Fourier Transform Infrared Spectroscopy-Attenuated Total Reflection (FTIR-ATR) mapping, on the surfaces of the resin fine particles is 0.20 to 0.40, and the proportion of the intensity ratio (P₂₈₅₀/P₈₂₈) having at least 0.40 is 10 to 50 percent.

### Aspect 6

A toner contains the resin fine particle composition of Aspect 5 mentioned above.

### Aspect 7

A distilling device includes a distilling tank including a wall, to store a resin dispersion containing an organic solvent, water, a resin, and a surfactant, and a heating device connected to a heat pump to heat the wall, wherein the heating device connected to a heat pump to heat the wall to change the temperature inside the distilling tank stepwise, to distill the resin dispersion to remove the organic solvent from the resin dispersion.

The above-described embodiments are illustrative and do not limit the present invention. This, numerals additional modifications and variations are possible in light of the above-teachings. For example, elements and/or features of difference illustrative embodiments may be combined with each other and/or substituted for each other within the scope of the present invention. Any one of the above-described operations may be performed in various other ways, for example, in an order difference from the one described above.

1. A method of manufacturing resin fine particles, comprising:
preparing a resin dispersion containing an organic solvent, water, a resin, and a surfactant; and
distilling the resin dispersion to remove the organic solvent,
wherein a mass ratio of the resin to the surfactant is from 1:1 to 1:2.

2. The method according to claim 1,
wherein the resin fine particles have a volume average particle diameter of 10 to 30 μm.

3. The method according to claim 1,
wherein the surfactant comprises sodium dodecyldiphenyl ether disulfonate.

4. The method according to claim 1,
wherein the organic solvent comprises ethyl acetate.

5. Resin fine particles comprising:
a resin comprising a polyester resin;
a colorant;
a release agent; and
a surfactant,
wherein the resin fine particles have a volume average particle diameter of 10 to 30 μm,
wherein the surfactant has a concentration of 500 to 1000 ppm at surfaces of the resin fine particles,
wherein an average value of an intensity ratio (P₂₈₅₀/P₈₂₈) of an absorption spectral peak intensity P₂₈₅₀ at a wavenumber of 2850 cm⁻¹ to an absorption spectral peak intensity P₈₂₈ at a wavenumber of 828 cm⁻¹, as determined by Fourier Transform Infrared Spectroscopy-Attenuated Total Reflection (FTIR-ATR) mapping, on the surfaces of the resin fine particles is 0.20 to 0.40,
wherein a proportion of the intensity ratio (P₂₈₅₀/P₈₂₈) having at least 0.40 is 10 to 50 percent.

6. A toner comprising the resin fine particle composition of claim 5.

7. A distilling device comprising:
a distilling tank comprising a wall, to store a resin dispersion containing an organic solvent, water, a resin, and a surfactant; and
a heating device connected to a heat pump to heat the wall,
wherein the heating device changes a temperature inside the distilling tank stepwise, to distill the resin dispersion to remove the organic solvent from the resin dispersion.
